(19) United States
(12) Patent Application Publication
(10) Pub. No.: US 2024/0085193 A1
(43) Pub. Date: Mar. 14, 2024

(54) AUTOMATED DYNAMIC ROUTING UNIT AND METHOD THEREOF

(71) Applicant: Swiss Reinsurance Company Ltd., Zürich (CH)

(72) Inventors: Riccardo TISSEUR, Zürich (CH); Luigi DI LILLO, Zürich (CH); Matteo MAFFETTI, Zürich (CH)

(73) Assignee: Swiss Reinsurance Company Ltd., Zürich (CH)

(21) Appl. No.: 18/372,305

(22) Filed: Sep. 25, 2023

Related U.S. Application Data
(63) Continuation of application No. PCT/EP2022/073128, filed on Aug. 18, 2022.

(30) Foreign Application Priority Data
Aug. 19, 2021 (CH) 070184/2021

(51) Int. Cl. G01C 21/34; G01C 21/36

(52) U.S. Cl. CPC G01C 21/3415; G01C 21/3446; G01C 21/3461; G01C 21/3492; G01C 21/3691

(57) ABSTRACT

Proposed is a vehicle embedded or mobile-phone-based, automated dynamic routing unit associated with a vehicle and/or a user along a route traveled and method thereof. The dynamic routing unit provides an optimized route between a departure location and a destination location, wherein the automated dynamic routing unit comprises a routing interface for receiving destination input parameters of a destination location and/or departure location input parameters of a departure location, and wherein the automated dynamic routing unit comprises a routing generator for generating one or more routes between the departure location and the destination location.

### CROSS REFERENCE TO RELATED APPLICATIONS

The present application is a continuation application of International Patent Application No. PCT/EP2022/073128, filed Aug. 18, 2022, which is based upon and claims the benefits of priority to Swiss Application No. 070184/2021, filed Aug. 19, 2021. The entire contents of all of the above applications are incorporated herein by reference.

### FIELD OF THE INVENTION

The present invention relates to devices, systems, and methods for providing a safest route, i.e. the route giving the most minimal probability measure (a minimized probability measurand value) for the possibility of an occurring accident event with a physical impact to a specific vehicle (also referred to as risk of being involved in a physically and actually occurring accident event occurring time-coincident to a vehicle passing a specific location along a driven route or generally a user passing on a specific location along a route traveled) between a source and a destination, for example, for a vehicle, from one or more routes between the source and the destination. Further, the invention relates also to devices, systems, and methods for providing the most optimized route in terms of CO₂ emission and/or CO₂ output and in terms of the generated CO₂ footprint of a specific motor vehicle driving that route, respectively. In addition, it relates to devices, systems, and methods for communicating at least one of a notification or control instructions to an automobile control unit to display the safest route and/or the new route with the minimal CO₂ footprint or control the automobile to navigate on the safest route or the new safest route.

### BACKGROUND OF THE INVENTION

Navigation systems are being increasingly used to provide route planning, location information, directions to or maps of places of interest, and other details of a journey. Some navigation systems provide detailed directions from a source location (or current location) to a destination location, and may thus help a driver navigate through areas with which they are not familiar. Based upon the source location and the destination location, the navigation system generates an optimum route between the two points. Typically, the route is optimized for distance, time or avoiding freeways or tollways, etc. Route optimization is typically performed by checking a number of possible routes, and selecting the “best” route based on one or more optimization criteria and/or specific parameter values constellations or specific constellations of parameter threshold values. Various techniques have been developed for constructing a route which is the most desirable according to predetermined optimization criteria. For instance, the shortest possible route may be chosen to minimize the distance traveled or high-speed roads may be chosen to minimize travel time. Other navigation systems may utilize real-time traffic congestion data in an attempt to determine a route that may help to guide the vehicle away from traffic jams. In addition, optimization criteria have been provided for avoiding freeways, maximizing use of freeways, avoiding tollways, for example.

Drivers and passengers assume a certain degree of risk of injury or property damage when travelling by vehicle caused by the occurrence of an impacting accident event. This risk may be mitigated by reducing or eliminating certain contributing factors. For example, a driver may avoid risky behavior, such as driving while intoxicated, driving while tired, or driving while texting. As another example, a driver may mitigate the risk of serious injury by driving a car with safety features such as airbags, seatbelts, and antilock brakes. However, certain risk factors may not be mitigated. For example, the very nature of a vehicle may present certain inherent risks. A typical car may weigh thousands of pounds and may not always maneuver or stop quickly. When travelling at even a moderate speed, a collision may result in serious physical damage to the vehicle and serious injury to the occupants. Further, a driver or passenger of a vehicle may have no control over perhaps the greatest risk factor involved with driving: other drivers or passengers in other vehicles. Further, environmental factors may contribute to the relative riskiness or safety of an area. For example, a driver approaching a one-lane bridge in a valley between two hills may not see the bridge until the vehicle has crested the hill. If the distance between the hill crest and the bridge is short, the driver may have little time to react if a second driver is approaching the bridge from the other direction. A driver may have little to no control over these environmental factors. Moreover, environmental factors contributing to the riskiness of an area may not always be readily apparent, observable, or quantifiable. For example, even if a civil engineer identifies a number of one-lane bridges as potentially dangerous, it may technically be difficult to quantifying how risky these one-lane bridges are relative to one another. Additionally, the engineer may overlook a two-lane bridge that is seemingly safe, but which is in actuality riskier than many of the identified one-lane bridges. Because the envi-ronmental factors contributing to risk may not always be 50 apparent, observable, or quantifiable, these environmental risk factors may go unnoticed. Thus, engineers and govern-ment officials may never identify certain high-risk areas, much less identify solutions to mitigate the risk and improve the safety of the areas for vehicle drivers and passengers. Further, in some situations, a driver or passenger may be exposed to high risk traffic situations that occur without advance notice and in a seemingly random fashion or at least driver-independent but merely time- and/or location-dependent. When relying on recommended routes from a navigation application or navigator during the course of travelling through unfamiliar locations, these high risk traffic situations may significantly increase travel times. Further these high risk traffic situations may be potentially dangerous to travel through. The routes may pass through hazardous areas, such as high risk intersections, road segments or portions of certain roads, abnormal traffic patterns, exit ramps, circular traffic flows, road construction areas, and the like, which may expose the driver or passenger to the risk of property damage, injury, time delay stemming from accidents, and the like.

In summary, there is an inherent risk involved with driving the vehicle along any of the routes, i.e. an inherent physical probability to be affected by an occurring accident event. Thus, driving a vehicle, almost worldwide, means that the driver somehow must or may want to reduce and optimized the risk exposure by selecting an optimal rout involving a minimized risk occurrence and/or transfer the remaining or otherwise not evadable risk, for example, by transferring or ceding the impact caused by the remaining risks by means of appropriate risk transfer systems or by risk cover provided by automated vehicle insurance systems fencing the user of a vehicle traveling a route with a certain risk-exposure impacted by an occurring physical accident event along said route traveled. The inventions should also provide a system automatedly providing a user with an optimized risk-cover (i.e. having an optimized route-based and/or usage-based pricing) upon selecting a more optimal route, i.e. a rout with a reduced inherent risk exposure. It should be mentioned that the probability of an accident occurrence on a specific route does not need to be the same for different vehicle drivers but may depend on the user-specific characteristics parameters measured or otherwise measured by the system. Thus, for an older vehicle driver having slower reaction times, the measured risk-exposure may be lower at low speed routes though there may occur more events having the possibility to become an accident event, where, however, for a younger driver, the risk exposure may be lower at a high speed route, where the traffic flow is more uniform.

The rate for the risk-transfer is normally assigned by a human expert, e.g., an auto insurance agent, deciding on whether a specific driver is a high or low-risk driver. Traditionally, the assigned human expert's rating considerations depend on only few different factors. For instance, one of the most common risk factors includes personal considerations that are used to calculate a driver's risk is age. For example, Drivers between the ages of 25 and 55 are considered to be in the prime age bracket and are considered a lower risk. Gender is another factor, since women drivers are usually considered as a lower risk in general, however, this is slowly changing because more and more registered drivers are women. Single parents are also considered as less of a risk. Risk transfer systems or insurances take into consideration that a single parent is already responsible enough to parent a child alone, so they are more likely to be financially responsible as well. In a similar vein, married drivers are normally rated better for their car risk-transfers or insurance policies than a single driver does. They are thought to be more stable than single drivers due to the fact that they often have more responsibilities. A single driver of the same age with the same driving record as a married person will be assessed as a higher risk simply because of their marital status.

Also, driving history plays a central role in the rating. If a driver has any type of driving violation attached to his driving history, he will be rated to a higher risk-transfer rate than someone whose driving record has no infractions. Any prior accidents that a driver has been involved in will be reflected on his driving record, which increases his risk rating. In some risk-transfer systems, even a severe penalty is put on such a driving record for up to five years after the accident has occurred. Any type of speeding ticket is normally also part of the driving history and raises a driver's risk factor. Speeding reflects carelessness and a disregard for the driving laws and official risk limits set in place by the government. Normally, risk-transfer systems will consider any type of speeding ticket as a bad reflection of the driver. This is calculated into the risk rating and will ultimately increase the rating or risk-transfer premium. Driving under the influence of alcohol or drugs, as reflected by the driving history, which may not only cause a moving violation ticket, but may also cause driver's license to become suspended or, worse case scenario, revoked. Therefore, as per traditional systems, the better a driving record or driving history is free of accidents, tickets, moving violations, the lower the risk rating will be which will result in lower insurance rates.

Further, the factor that, if a vehicle is used as a personal vehicle or strictly for business, affects in many prior-art systems the risk rating. In addition, the distance a driver drives to and from work every day is another factor that may be considered for the risk rating, in the prior-art. The less mileage a driver accrues per year, the less of a risk he is exposed. If a driver only drives a few miles a day to reach his job site, his risk of having an accident is lower, so his rating will be better. Also, teenage drivers are considered an extremely high risk when it comes to driving. Various prior-art risk rating statistics acknowledge that teenage drivers have an extremely high crash rate due to their inexperience and lack of maturity. Vehicle accidents are often the leading cause of death for teenagers. This is another factor that is used to rate a risk to be transferred, i.e., an insurance risk. In opposite to teenagers' specific rating, in some risk-transfer systems, the number of years a driver has been driving also matters. This is tied into the age factor of drivers, but some people do not always start driving as soon as they hit the legal age. A driver of the same age who has been driving for the last 10 years will be rated significantly lower because such drivers typically are considered to be less of a risk.

Another factor is the area where the driver resides, which typically plays a major role in how a car risk-transfer is rated. Drivers who, for example, claim a residence in a larger metropolitan area run a higher risk of not only being involved in an accident but also of being the victim of vandalism or theft. Cities are congested with much more traffic than urban areas. The logic of prior-art risk-transfer is that the more cars that are used in an area, the more likely they are to hit or be hit by another car. Those drivers who live in an area that has less traffic will be considered less of a risk and that helps lower their risk-transfer ratings or premiums. Specific areas may further be specifically rated as being a high crime area. If a driver lives in such an area, the risk-transfer rating will be considered at a higher rate because the vehicle will be more likely to be involved in a theft.

Now, as discussed, conventional navigation systems typically favor criteria like shortest possible route for determining route between two points. However, some drivers may be more concerned about other factors that might otherwise influence their chosen route. For example, risk-conscious drivers might be more concerned about finding a relatively safe route that has a statistically low accident rate. Typically, every route that may be taken up by the driver of the vehicle is considered to have some risk associated therewith. The risk along any route may be due to various factors including a-priori of navigation risk associated with the routes, weather condition along the routes, driving area along the routes, condition of routes, number of intersections along the routes, and traffic congestion along the routes. Thus, there is a need to extend prior art systems to provide a navigation system that generates or selects a proposed route from a number of identified routes in a manner that favors relatively safe routes over relatively unsafe routes.

Also, from the above, it may be understood that traditional risk assessment of the prior-art systems mainly employs statistically based structures by appropriate class factors, e.g., age, gender, marital status, number of driving years etc., such assessments necessarily lead to preferred class ratings with the corresponding deficiencies in providing the correct risk for a specific driver. Statistical based structures are always linked to mean values and means assumptions. The deficiencies of the prior-art assumptions lay in the fact, that they contract all driver of a certain class to the means assumption of the class, while, in fact, this is only absolutely true for a very minor part of a certain class, while the predominant remaining members of the class typically are distributed in Poisson distribution around the means value, i.e., for this predominant remaining part, the assumption is more or less wrong leading to a probably unfair risk rating of the driver. Therefore, the prior-art systems risk predictions and ratings are afflicted with major deficiencies in relation to the actual occurring driving risk. Thus, it is a high demand on reliable, automated risk assessment and risk-transfer systems in the field of automobile risk-transfer industry, considering both liability and comprehensive risk-transfer. The field of automobile risk-transfer is characterized by highly competitive pressure as well as high combined ratios and, hence, by low profitability. Thus, there is a demand to provide automatable systems, even in the complex sector of physically measuring of typically (i.e., by prior-art systems) not measurable risks and system-based, automated risk-transfer. In particular, there is a need to extend prior art systems to provide a mechanism to reward risk-conscious drivers for following comparatively safer routes by helping with the risk transfer.

The prior art document US 2014/0074402 A1 discloses a system for determining of risks associated with driving routes. The system identifies a route of travel, segments the route in road segments and estimates the risk, i.e. the likelihood of a collision to occur associated with vehicular travel along the road segments of the route by accumulating the risk over all road segments based on static road characteristics, temporal road characteristics, historical accident information, incident information, and traffic violation information associated with the one or more first road segments, and estimating risk associated with vehicular travel along the probable routes by accumulating the estimated risk associated with vehicular travel along the first road segments. The document US 2021/0164792 A1 discloses a further system for determining risks of a route includes collecting a set of input parameter values and determining a set of risk scores. The system determines a model based on the set of inputs and determines a set of risk scores producing outputs based on the set of risk scores for an insurance company, such as an insurance rate and/or insurance rate adjustment based on a region in which the driver lives, a common set of routes driven by the driver, and the particular driver's behavior relative to the risk of the route. Finally, EP 2 221 581 A1 shows a system for estimating a propulsion-related operating parameter of a vehicle for a road segment. The system estimates a first operating parameter of the vehicle for the road segment based on information provided for the road segment, and further estimates the propulsion related operating parameter for the road segment based on the first operating parameter, the estimation taking into account vehicle specific parameters. The vehicle specific parameters comprise driving data for at least two vehicle operating parameters while the vehicle is in operation, wherein the system provides a predetermined relationship between two vehicle operating parameters, the relationship taking the vehicle specific parameter into account, and determines the vehicle specific parameter from said driving data for the two vehicle operating parameters and the relationship, wherein the propulsion-related operating parameter is fuel consumption, energy consumption, or carbon dioxide (CO₂) emission.

### SUMMARY OF THE INVENTION

It is one object of the present invention to provide an o provide an automated dynamic routing unit and an automated dynamic routing method for providing an automatedly optimized route (typically the route having the minimal probability (risk) for a physically impacting accident event to a selected motor vehicle and/or the route with the most minimized CO₂-footprint and/or minimal CO₂ emission/output for a selected motor vehicle) between a departure location and a destination location. In particular, the optimized route should be provided by automated technical means, i.e. machine-based optimized, having a minimized actual-measurable probability of an occurring accident event with a physical impact on the vehicle driving the route at the related temporal and geographical dependent contemporaneousness. Thus, it is an object of the invention to provide an automated system enabling a driver or an autonomous driving system to select the best possible route based on its exposure to traffic crash risk (event occurrences) along a specified route, more particularly together with providing trip feedback and/or safe alternate recommendations. The crash risk measure can e.g. be generated either “directly” in the case the system is measuring the number of incidents that occur on specific roads (or has otherwise access to such measuring data) or “indirectly” i.e. by first automated analyses and/or automated recognition of the correlation of road contexts (features that are measured and/or generated by the system based e.g. on the measured or recognized number of stops, intersections per kilometer, etc.) with the measured probability value of having a crash in region for which crashes and/or claims data are assessable and subsequently by generalizing the correlations learned to regions in which crashes and/or claims measuring data are e.g. too few or even absent. The used data can e.g. also be accomplished and/or refined and/or weighted/calibrated based upon historical data e.g. accessed from crashes database information. The system is, inter alia, based on the insight that a small set of locations typically accounts for a considerable portion of total occurrences of accident events in a traffic stream (typically the top 10% of crash locations approximately account for more than 66% of all the crashes). Further, by using the smart phone's built-in sensors or other measuring signals e.g. coming from connected cars' hardware devices, the inventive system should be enabled to run unobtrusive in the background and automatically detects when a driving session begins and ends. It then should be able to tracks the entire trip and provide the driver automatedly with a route risk score, which, inter alia, can be measured by monitoring past and/or historical traffic accident events along the route. The present disclosure generally relates to reducing vehicle collisions and increasing vehicular safety and, further, to providing automated near real-time feedback on route safety and associated risks.

According to the present invention, these objects are achieved, particularly with the features of the independent claims. In addition, further advantageous embodiments can be derived from the dependent claims and the related descriptions.

According to the present invention, the above-mentioned objects for the vehicle embedded or mobile-phone-based, automated dynamic routing unit, and corresponding method thereof, associated with a vehicle and/or a user along a route traveled between a departure location and a destination location, are achieved, particularly, in that destination input parameters of a destination location and/or departure location input parameters of a departure location are received by a routing interface, one or more routes between the departure location and the destination location are generated by a routing generator, in that a measuring unit dynamically measures and forecast for each of the generated routes time- and location dependent measured exposure values given by measured and forecasted time- and location dependent probability values quantitatively measuring the probability for occurrences of impacting accident events along the one or more routes, the impacting accident events occurring temporal and spacial coincidentally at a respective location of the vehicle and/or user traveling along a route, wherein the measuring unit measures and forecasts said time- and location dependent probability values by processing measured route parameters associated with the generated routes, wherein the measured route parameters comprise at least a-priori of navigation risk parameters, weather condition parameters, driving area parameters, condition parameters, number of intersections, traffic congestion parameters and/or further risk-exposer related measure parameters along the routes, in that the measuring unit generates an aggregated exposure score measure for each of the routes based on the measured route parameters and/or the time- and location dependent exposure values, in that a route selector automatedly selects the most optimized route among the generated routes based on the aggregated exposure score measure values and/or the measured route parameters and/or the time- and location dependent exposure values and/or user-specific parameter values, and in that the automated dynamic routing unit provides the selected optimized route as output signaling on the routing interface.

According to the present disclosure, the above-mentioned objects for the vehicle embedded or mobile-phone-based, automated dynamic routing unit and the automated dynamic routing method for providing an optimized route between a departure location and a destination location are achieved in that for minimizing the probability of being impacted by an occurring accident event, have relevant consequences and advantages for both human drivers and autonomous driving systems. Herein, instead of focusing on the mitigation of the physical impact of an accident event, such a risk-transfer solutions, the present dynamic routing unit is able to proactively effect on the prevention for the occurrence of accident events, and thus enable the drivers (or generally a user traveling from one location to another location) to enjoy safer trips by minimizing the probability of being involved in risky situations. The present dynamic routing unit minimizes both a-priori and real-time occurring risks (i.e. the physical probability to be impacted by an occurring accident event) along a route like hazardous weather conditions, driving area, dangerous roads (multiple connotations of danger), traffic congestion and/or the physical state of the user. The present dynamic routing unit may further be used for generating an optimized dynamic risk-transfer cover using mobile telematics data capturing etc. The present dynamic routing unit may not only be limited to road-based vehicle safety but also be applicable for maritime risk routing, and the like. It is to be noted that the vehicle embedded or mobile-phone-based, risk-based automated dynamic routing unit can be realized as a hardware- and/or software-based vehicle embedded unit or as a mobile application running on a mobile phone, such as a cellular smart phone.

Further, the present invention disclose a system and method that generally is able to reduce physical vehicle collisions, and particularly, inter alia, to identifying or selecting a travel route for a vehicle (or a user, e.g. traveling from a starting hiking point to a destination hiking point, or kind of transportation means, such as bikes, ships, vessels, planes or any other flight transportation vehicle) that avoids traversing the areas that are prone to vehicle collisions. As discussed, hazardous areas (e.g., high risk intersections, road segments or portions of certain roads, bridges, abnormal traffic patterns, exit ramps, circular traffic flows, road construction areas, parking lots, and other transportation infrastructure) are prone to induce, or be associated with, vehicle collisions. A relative amount in which an area is hazardous can vary with time. As an example, a roadway may pose minimum driver risk during the daytime, but, based on any number of factors (e.g., poor illumination); the roadway may be associated with an increased number of vehicle collisions. Upon receiving a request for a desired destination for vehicular travel, both historical route measuring data and near real-time or real-time route measuring data (in particular telematics measuring and sensory data) for a number of potential travel routes is accessed. One way to measure how hazardous an area can e.g. include the generation of a risk index for the area that is based on the historical route data and/or near real-time route measuring data. The term “risk index”, as used herein, is not a human-empirical parameter, but explicitly denotes a machine- and measuring devices-based physical and thus by means of the used technical means (measuring devices, sensors, telematics, machine-learning structures etc.) automatedly reproducible, quantified physical measure. The risk index quantifies how prone or exposed the area is to vehicle collisions. When risk indices are generated for more than one area, the risk indices may be compared to one another to enable a comparison of the relative riskiness of several areas.

Generally, the near real-time or real-time route measuring data (i.e. the route parameter values and/or the user-specific parameter values), in particular including the real-time telematics measuring data from the vehicle or an associated the driver or passenger of the vehicle or the user of the dynamic routing unit in general, can be used to ascertain whether a particular route is currently experiencing an event and/or parameters setting that may impact how risk associated with the route, i.e. the measurable quantitative probability for being involved in an occurring accident event with a measurable physical impact to the user and/or the vehicle. Examples of potential events that may impact route risk include accidents, increased or decreased traffic, and road engineering occurrences (e.g., construction, lane blockages, and the like) on the route. The real-time route measuring data can e.g. be combined with historical route measuring data to generate and measure an aggregated or location dependent quantifiable physical exposure score (or risk index) parameter value. The exposure herein is the exposure to an actual occurring accident event with a physical impact to the vehicle and/or the user. Specifically, the exposure measure or risk measure can be generated and measured based on a (machine-learning-based) comparison or matching between the number of expected collisions, the number of observed collisions, and the number of real-time occurring events occurring on the route to be monitored and measured. Subsequent to generating the physical measurable exposure score value, the system and method can provide an optimized travel route for a vehicle based upon an aggregate exposure score parameter value over that travel route. Upon selecting a desired travel route, the desired travel route may be presented to a device to facilitate routing of the vehicle according to the selected travel route. In these examples, the device (dynamic routing unit) may be one of a mobile device, an on-board computer, and a navigator associated with a vehicle, operator or passenger of a vehicle, pedestrian, bicyclist, and the like. The systems and methods may further periodically access real-time route data for the selected desired travel route and generate updated time- and location-dependent measured exposure values or updated aggregated exposure score measures for the generated routes based on the measured real-time route data or the measured user-specific parameter data and/or the historical route measuring data. Further, the system and method can provide updated and optimized information for the selected desired travel route and can further provide alternative routes based on the updated measured exposure scores that avoids traversing the area based upon the time- and location-dependent exposure scores or based upon lower aggregate exposure scores for specific routes, via wireless communication or data transmission over one or more radio links or wireless communication channels.

Further, generating and/or measuring the exposure scores can include using historical route measuring data and real-time route measuring data. The historical route measuring data can be used to generate a number of expected collisions, i.e. actual measured accident events in a forecasted time frame, in an area over a time period and determine a number of observed collisions in the area over the time period. The number of expected and observed collisions may be calculated based upon (a) historical traffic measuring data for the area, and/or (b) historical traffic measuring data for multiple areas, such that the number of expected and observed collisions may correspond to the risk/exposure measuring score value for the area and/or exposure score vales for multiple areas (e.g., mean, median, or mode of the exposure/risk indices). Examples of historical traffic data can also include historical vehicle risk-transfer claim data and/or other data, such as vehicle collision data, mobile device measuring data, telematics measuring data, vehicle mounted-sensor data, autonomous vehicle sensor data, smart infrastructure sensor data, and image measuring data. The number of expected collisions may comprise a direct or indirect relation to the measured traffic volume or flow, and may be further adjusted for market penetration. The number of observed collisions may be limited to observations involving vehicles within the market corresponding to the market penetration of the vehicles.

The measuring process by means of the system and method can e.g. further include predefined threshold values for determining or triggering that the measured risk index parameter value for an area, or the aggregated exposure score parameter value over a specified route exceeds one of said predetermined threshold parameter values. If the exposure score for the area, or if the aggregated exposure score over a specified route exceeds a predetermined threshold, the area or route may be classified as high risk or hazardous. Such a determination may be used as definable classification criteria by the system when selecting or detecting a travel route for a vehicle that avoids the hazardous area or specified route having an exposure score vale exceeding the predetermined threshold. If the exposure score for the area does not exceed the predetermined threshold, the area may be classified as low/lower risk or not-hazardous, and the selected travel route may either traverse or not traverse the non-hazardous area. Such a system-defined classification allows a binary or multi-class selection of the most optimized or user-selected level of risk exposure along the various possible routes.

In an embodiment variant, the vehicle embedded, or mobile-phone-integrated automated dynamic routing unit comprises a data acquisition unit for continuously acquiring the route and/or user-specific parameters along the routes. If the present invention is embedded in the vehicle, the present disclosure provides technical means to collect telematics data via cellular mobile device or mobile telematics devices. Modern smartphones are more than calling devices, and incorporate a number of high-end sensors that provide new dimensions to the smartphone experience. Thus, the use of smartphones may be extended from the usual telecommunication field to applications in other specialized fields including transportation. Sensors embedded in the smartphones like GPS, accelerometer and gyroscope may collect data passively, which in turn may be processed to infer the travel mode of the smartphone user. This may help solving many of the shortcomings associated with conventional travel survey devices and systems including biased response, no response, erroneous time recording devices, etc. For example, the present dynamic routing unit uses the sensors' data collected by smartphones or mobile telematics devices to extract various features for classification, including data frequency, moving temporal window size and proportion of data to be captured, are dealt with to achieve better results. In an implementation form, the mobile telematics devices associated with the plurality of motor vehicles comprise one or more wireless or wired connections, and a plurality of interfaces for connection with at least one of a vehicle's data transmission bus, and/or a plurality of interfaces for connection with sensors and/or measuring devices, wherein, for providing the wireless connection, the mobile telematics device acts as wireless node within a corresponding data transmission network by means of antenna connections of the mobile telematics device. In an implementation form, the mobile telematics devices are connected to an on-board diagnostic system and/or an in-car vehicle interactive device, and wherein the mobile telematics devices capture usage-based and/or user-based and/or operation-based telematics data of the motor vehicle and/or user.

In another embodiment variant, the automated dynamic routing unit comprises a route monitoring unit for continuously monitoring the risk parameters along the routes to determine change in the route parameters along the routes and/or the user-specific parameters, wherein in response to a change in the measured route parameters for at least one of the one or more routes, the automated dynamic routing unit dynamically re-determines at least partially the time- and location dependent measured exposure values along each route based on the route parameters, wherein further in response to at least one changed time- and location dependent measured exposure value, the automated dynamic routing unit dynamically generates an updated exposure score for each of the routes, and determines an updated optimized route among the one or more routes, and wherein the updated optimized route is provided as output on the embedded routing interface unit. Thus, the present disclosure allows to react dynamically on captured environmental or operational parameters, and further to telematics system's monitoring, capturing and reacting on motion parameters of motor vehicles during operation, and thereby dynamically determining routes and routes segments with higher measured probabilities for the occurrence of an impacting accident event, and suggest one or more alternate optimized routes with lower probability.

In another embodiment variant, the dynamic routing unit can e.g. comprise an automobile interface unit communicating at least one of a control instructions or the optimized route to an automobile control unit, the automobile control unit being connected to or comprising an Advanced Driver Assistance System (ADAS) or an autonomous driving system of the vehicle, wherein the optimized route is automatically chosen to be driven by the autonomous driving system or upon selection by the user. Conventionally, autonomous vehicles may detect certain objects, do basic classification, alert the driver of hazardous road conditions and, in some cases, automatically decelerate or stop the vehicle; however, with implementation of the present vehicle embedded, risk-based automated dynamic routing unit, such vehicles may enable the user(s) to enjoy safer trips which minimize the probability of encountering risky situations. To achieve safer trips, the present automated dynamic routing unit, such vehicles proactively avoids risky routes, instead of focusing on the mitigation of the physical impact of an occurred accident event.

The present automated dynamic routing unit also provides means for reacting, in real-time, dynamically on captured motion, environmental or operational parameters of mobile telematics devise and/or motor vehicles during operation, in particular allowing a user to dynamically and in real-time adapt vehicle's operation or driving risks by means of an automated risk-transfer engine allowing to dynamically select appropriate usage-based risk-transfer profiles based on monitoring, capturing and reacting on automotive parameters of motor vehicle during operation or the physical condition of the user based on the user-specific parameters. More particularly, the present dynamic routing unit extends the existing technology to a dynamic triggered and dynamically adjustable, multi-tier risk-transfer system based on a dynamic adaptable or even floating first-tier level risk-transfer, thereby reinforcing the importance of developing automated systems allowing self-sufficient, real-time reacting operation.

The present automated dynamic routing unit further provides a way to technically capture, handle and automate dynamically adaptable, complex and difficult to compare risk transfer structures by the user and trigger operations that are related to automate optimally shared risks and transfer operations. The present dynamic routing unit further seeks to dynamically synchronize and adjust such operations to changing environmental or operational conditions by means of telematics data invasive, harmonized use of telematics between the different risk-transfer systems based on an appropriate technical trigger structure approach, thus making the different risk-transfer approaches comparable.

To realize the present automated dynamic routing unit, one or more data processing systems and/or computers may perform particular operations or actions by virtue of having software, firmware, hardware, or a combination of them installed on the system that in operation causes or cause the system to perform the actions. One or more executable codes may perform particular operations or actions by virtue of including executable instructions that, when executed by data processing apparatus, cause the apparatus to perform the actions.

In another aspect, an automated dynamic routing method for providing an optimized route between a departure location and a destination location, is characterized by steps of: (i) receiving destination input parameters of a destination location and/or departure location input parameters of a departure location via a routing interface, (ii) generating one or more routes between the departure location and the destination location by a routing generator, (iii) dynamically measuring and forecasting, by means of a measuring unit, for each of the generated routes time- and location dependent measured exposure values given by measured and forecasted time- and location dependent probability values quantitatively measuring the probability for occurrences of impacting accident events along the one or more route, the impacting accident events occurring temporal and spacial coincidentally at a respective location of the vehicle and/or user traveling along a route, wherein the measuring unit measures and forecasts said time- and location dependent probability values by processing measured route parameters associated with the generated routes, wherein the measured route parameters comprise at least a-priori of navigation risk parameters, weather condition parameters, driving area parameters, condition parameters, number of intersections, traffic congestion parameters and/or further risk-exposer related measure parameters along the routes, (iv) generating, by means of the measuring unit, an aggregated exposure score measure for each of the routes based on the measured route parameters and/or the time- and location dependent exposure values, (v) selecting, by means of a route selector, the most optimized route among the generated routes based on the aggregated exposure score measure values and/or the measured route parameters and/or the time- and location dependent exposure values and/or user-specific parameter values, and (vi) providing the selected optimized route as output on the routing interface unit.

In an embodiment variant, the automated dynamic routing method further comprises continuously acquiring the route parameters along the routes and/or the user-specific parameters from one or more measuring/monitoring/data-acquisition sources. In another embodiment variant, the automated dynamic routing method further comprises the steps of (i) continuously monitoring the route parameters along the routes and/or the user-specific parameters to determine possible occurring changes in the route parameters along the routes and/or the user-specific parameters, in particular form one or more measuring devices and/or sensors associated with the vehicle and/or the mobile device and/or the user and/or external contextual measuring systems, (ii) in response to a change in the measured route parameters for at least one of the one or more routes, dynamically re-determining at least partially the time- and location dependent measured exposure values along each route based on the route parameters, (iii) in response to at least one changed time- and location dependent measured exposure value, generating an updated exposure score for each of the routes, (iv) determining an updated optimized route among the one or more routes, and providing the updated optimized route as output on the embedded routing interface unit. In another embodiment variant, the automated dynamic routing method further comprises the step of triggering, for selecting the most optimized route, by means of the route selector, for the most optimized route among the routes, using the values of the aggregated exposure score measure of the routes, wherein the most optimized route is triggered by the route having the smallest aggregated exposure score measure value, or by the route having the smallest maximum value of a time- and location dependent measured exposure values along each route.

In a further embodiment variant, the system and methods can further include generating a notification based upon the measured exposure score values or aggregated exposure score values and/or measured route parameter values. Such notification can e.g. be a generated virtual navigation map or a generated audible, visual, or physical haptic alert. For example, the virtual navigation map can visually depict the risk index. The virtual navigation map may include graphic elements depicting risk indices for one or more areas. The virtual navigation map can be in the form of a heat map. The system and method can further transmit the generated notification to an electronic device (e.g., mobile device, an on-board computer, wearable electronics including an augmented reality appliance, and a navigator) associated with a vehicle, operator or passenger of a vehicle, pedestrian, bicyclist, and the likes to facilitate routing or re-routing that avoids traversing the area based upon the risk index, via wireless communication or data transmission over one or more radio links or wireless communication channels. The electronic devices may receive such notifications when approaching the high risk or hazardous area (e.g., an area having a measured exposure score value exceeding a prede-termined threshold value). The notification can e.g. indicate that potentially hazardous traffic conditions such as merging traffic, abnormal traffic flow, reduced number of lanes (e.g., 3 lanes being condensed to 2 lanes), on-going road construction, and suboptimal road surface resulting from inclement weather conditions are on the route ahead. The system and method may include additional, less, or alternate functionality, including that discussed elsewhere herein.

Other embodiment variants and advantages of the inventive system and/or method will become apparent from the following detailed description, taken in conjunction with the accompanying drawings, which illustrate by way of example the teachings of the disclosure, and are not restrictive.

### BRIEF DESCRIPTION OF THE DRAWINGS

The present invention will be explained in more detail below relying on examples and with reference to these drawings in which:

FIG. 1 shows a diagram, schematically illustrating an exemplary architecture of a vehicle embedded or mobile-phone-based automated dynamic routing unit for providing an optimized route between a departure location and a destination location, according to some embodiments.

FIG. 2 shows a diagram, schematically illustrating an exemplary architecture of an automated dynamic routing unit for continuously acquiring route parameters along one or more routes and/or user-specific parameters, according to some embodiments.

FIG. 3 shows a diagram illustrating an exemplary vehicle with a telematics unit for determining route parameters in real-time, according to some embodiments.

FIG. 4 shows a diagram, schematically illustrating an exemplary architecture of an automated dynamic routing unit for continuously monitoring route parameters and updating the optimized route, according to some embodiments.

FIG. 5 shows a diagram, schematically illustrating an exemplary architecture of an automated dynamic routing unit for configuring the automobile to navigate on the optimized route, according to some embodiments.

FIG. 6 shows a flow diagram, schematically illustrating an automated dynamic routing method for providing an optimized route between a source location and a destination location, according to some embodiments.

FIG. 7 shows a block diagram, schematically illustrating a vehicle embedded or mobile-phone-based, automated dynamic routing unit 100 associated with a vehicle 800 and/or a user 700 along a route 122 traveled. The dynamic routing unit 100 provides an optimized route between a departure location 1221 and a destination location 1222. The automated dynamic routing unit 100 comprises a routing interface 110 for receiving destination input parameters 112/1121 of a destination location 1221 and/or departure location input parameters 112/1122 of a departure location 1222. The automated dynamic routing unit 100 comprises a routing generator 120 for generating one or more routes 1201 between the departure location 1221 and the destination location 1222.

FIG. 8 shows a block diagram, schematically illustrating route 122 traveled. between a departure location 1221 and a destination location 1222.

FIG. 9 shows a diagram, schematically illustrating an embodiment variant with a set of Pareto efficient route solutions 1201 generated through a routing process 600 in the selected scenario by the route generator 120. Each axis represents a different criterion: x axis—travel time, y axis—navigation added measure and z axis—navigation risk. The generated routes 1201 can e.g. be grouped by appropriate indications.

FIG. 10 shows a diagram, schematically illustrating an embodiment variant providing a trade-off between different criteria. A set of pareto efficient route solutions 1201 generated by the route generator 120 through the routing process 600 in the selected scenario. The generated routes 1201 are illustrated in the 3-dimension space: x axis—travel time, y axis—navigation added navigation measure and the color domain to identify the routes by risk. The red triangular marker identifies the optimized route 1401/1402 representing the best trade-off solution for the route selector 140.

### DETAILED DESCRIPTION OF THE PREFERRED EMBODIMENTS

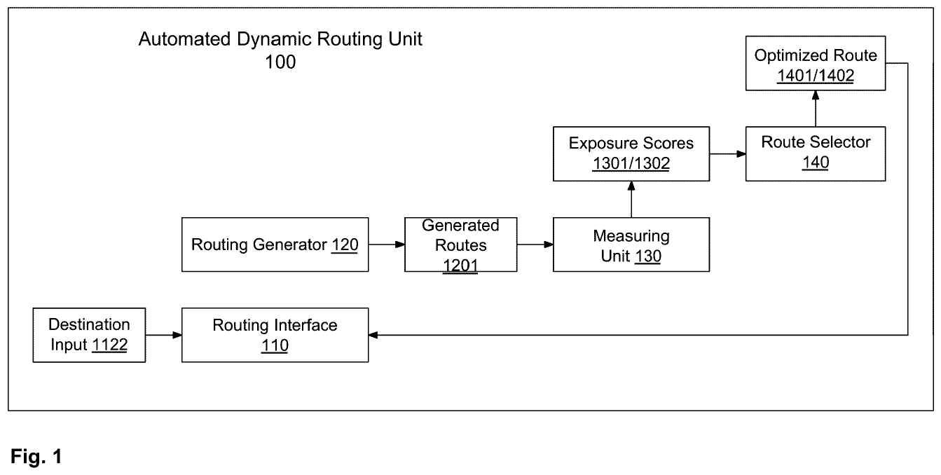

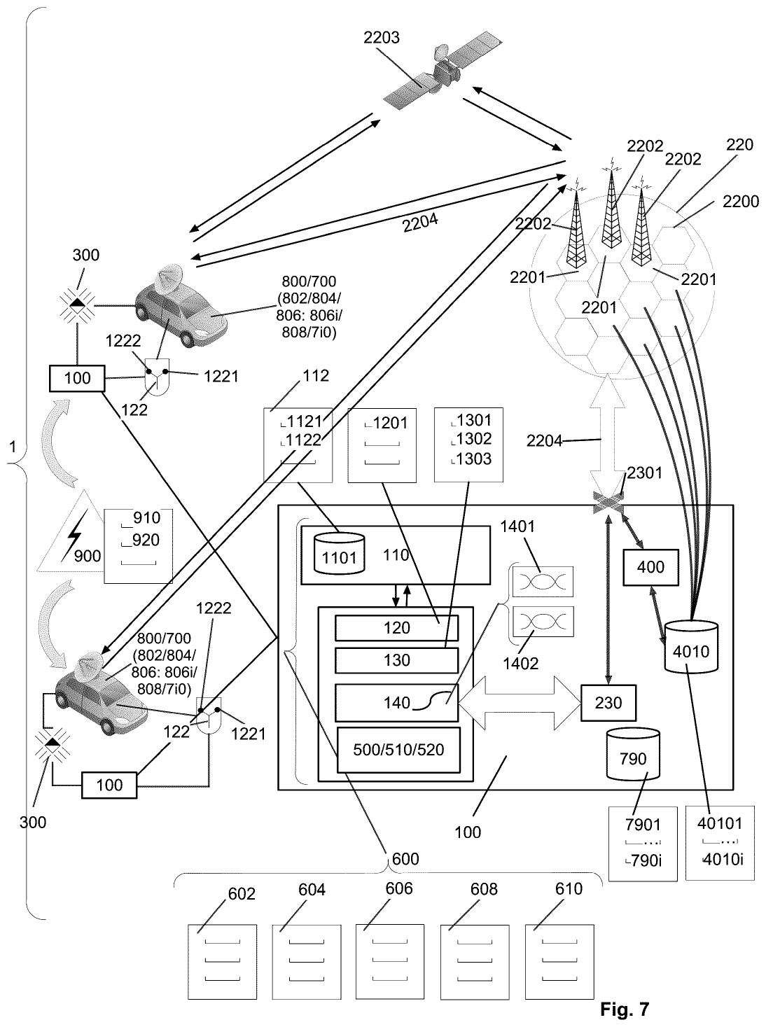

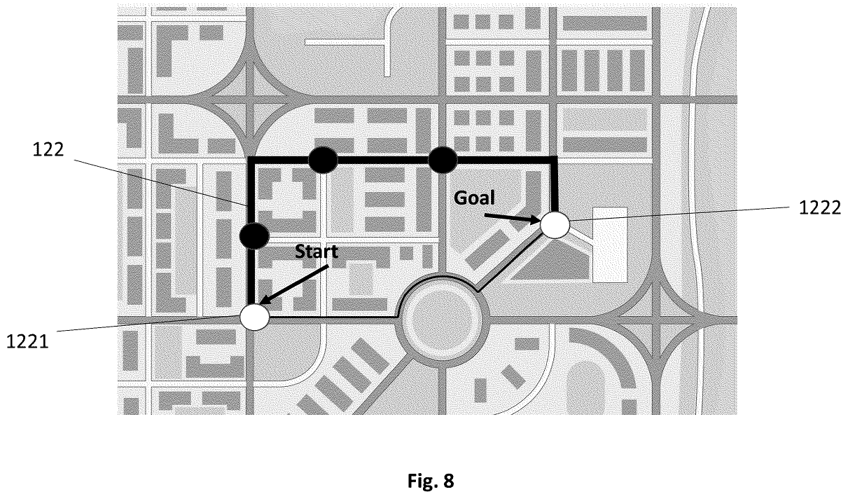

FIGS. 1 to 8 schematically illustrate an architecture for a vehicle embedded, or mobile-device-based (as e.g. mobile phone or another electronic mobile device) automated dynamic routing unit 100 and an automated dynamic routing method for providing an optimized route, according to the invention. The present automated dynamic routing unit 100 is associated with a vehicle 800 and/or a user 700 along a route 122 traveled. The dynamic routing unit 100 provides an optimized route between a departure location 1221 and a destination location 1222. By means of a routing interface 110 of the automated dynamic routing unit 100 destination input parameters 112/1121 of a destination location 1221 and/or departure location input parameters 112/1122 of a departure location 1222 are received. By means of a routing generator 120 of the automated dynamic routing unit 100 one or more routes 1201 are generated between the departure location 1221 and the destination location 1222.

A measuring unit 130 of the dynamic routing unit 100 dynamically measures and forecasts for each of the generated routes 1201 time- and location dependent measured exposure values 1301 given by measured and forecasted time- and location dependent probability values quantitatively measuring the probability for occurrences of impacting accident events 900/910/920 along the one or more routes 1201. The possibly impacting accident events 900/910/920 occur temporal and spatial coincidentally at a forecasted location of the vehicle 800 or user 700 traveling along a route 1201. The measuring unit 130 measures and forecasts said time- and location dependent probability values 1301 by processing measured route parameters 40101 associated with the generated routes 1201 and/or user-specific parameters 790. The measured route parameters 40101 comprise at least a-priori of navigation risk parameters 40101 and/or weather condition parameters 40102 and/or driving area parameters 40103 and/or condition parameters 40104 and/or number of intersections 40105 and/or traffic congestion parameters 40106 and/or further risk-exposer related measure parameters 40107 along the routes 1201. The measuring unit 130 provides an aggregated exposure score measure 1302 for each of the routes 1201 based on the measured route parameters 4010/40101-40107 and the time- and location dependent exposure values 1301.

In an additional embodiment variant, the inventive system and method relates also to devices, systems, and methods for providing additionally or alone the most optimized route in terms of CO₂ emission and/or CO₂ output and in terms of the generated CO₂ footprint of a specific motor vehicle driving that route, respectively. In this variant, the measuring unit 130 of the dynamic routing unit 100 dynamically measures and forecasts for each of the generated routes 1201 time- and location dependent measured values 1301 given by measured and forecasted time- and location dependent values quantitatively measuring the CO₂ emission and/or CO₂ output and thus the CO₂ footprint of the route measuring physical measurands at least comprising number of stops and/or type of road (highway vs other) and/or steepness of the road etc.

A route selector 140 of the automated dynamic routing unit 100 selects the most optimized route 142) among the one or more routes 120 based on at least the time- and location dependent measured exposure values 1301 along each route 1201 and/or the aggregated exposure score measures 1302 of the routes 1201 and provides the selected optimized route 1401 as output on the embedded routing interface unit 110.

The present disclosure may implement a processor for controlling overall operation of the vehicle embedded, risk-based automated dynamic routing unit and its associated components, including RAM, ROM, input/output module, and memory. I/O-device may include a microphone, keypad, touch screen, and/or stylus through which a user of vehicle may provide input and may also include one or more of a speaker for providing audio output and a video display device for providing textual, audiovisual, and/or graphical output. Software may be stored within memory to provide instructions to the processor(s) for enabling the system to perform various functions. For example, memory may store software used by the system, such as an operating system, application programs, and an associated databases. Processor and its associated components may allow the system to run a series of computer-readable instructions to analyze routing data and risk parameters. In addition, processor may determine an optimized route and transfer the determined optimized route to a display for the user 700 of the vehicle 800. In some implementations, the processor may operate in a networked environment supporting connections to one or more remote clients, such as terminals, PC clients and/or mobile clients of mobile devices. The processor can further comprise data stores for storing routing data, including routes that have been analyzed thereby in the past.

Appropriate network connections can e.g., include a local area network (LAN) and a wide area network (WAN) but may also include other networks. When used in a LAN networking environment, the automated dynamic routing unit 100 can be connected to the network through a network interface. When used in a WAN networking environment, the automated dynamic routing unit 100 includes means for establishing communications over the WAN, such as the Internet. The existence of any of various well-known protocols such as TCP/IP, Ethernet, FTP, HTTP, and the like is presumed. Additionally, an application program used by the automated dynamic routing unit 100 according to an embodiment of the disclosure may include computer executable instructions for invoking functionality related to determining a safe route and displaying the safe route for the user. In some implementations, the present automated dynamic routing unit 100 may be in the form of a mobile device, as e.g., smart phones, including various other components, such as a battery, speaker, camera, and antennas.

The inventive optimized routing have relevant consequences for both the human as driver and autonomous driving systems. Herein, instead of focusing on the mitigation of a possible impact of an occurring accident event to the user 700 or vehicle 800, such as risk-transfer solutions, the present dynamic routing unit 100 can proactively work on prevention, and thus enable the drivers to enjoy safer trips by minimizing the probability of encountering risky situations. The present dynamic routing unit 100 minimizes both a-priori and in real time exposures to possibly occurring accident events along a route like hazardous weather conditions, driving area, dangerous roads (multiple connotations of danger) and traffic congestion. The present dynamic routing unit 100 may further be used for generating an optimized dynamic risk-transfer cover using mobile telematics data capturing etc. The present dynamic routing unit may not only be limited to road based vehicle safety but also be applicable for maritime risk routing, and the like.

In particular, FIG. 1 depicts an architecture of an automated dynamic routing unit 100 (hereinafter, sometimes, referred to as “dynamic routing unit 100”) for providing the optimized route between a departure location and a destination location, according to some embodiment variants. In one implementation, the dynamic routing unit 100 may be implemented as a device having processor and memory. In another implementation, the dynamic routing unit 100 may be implemented as a circuit or a specialized processing chip in a vehicle control system or as a part of Advanced Driver-Assistance Systems (ADAS). In one or more implementations, the dynamic routing unit 100 may be implemented or executed by one or multiple computing devices. The dynamic routing unit 100 may be reside or embedded into the vehicle for increasing the navigation safety and reducing risk due to various vehicle-dependent, user-specific and/or contextual factors on the routes. The dynamic routing unit 110 may be executed by one or multiple computing devices, which may be connected to a network (e.g., the internet or a local area network), such as a network. Examples of computing devices may include, but are not limited to, a personal computer(s), a laptop computer(s), mobile computing device(s), a server computer, a series of server computers, a mainframe computer(s), or a computing cloud(s).

In certain implementations, the computing device may be a physical or virtual device. In many implementations, the computing device may be any device capable of performing operations, such as a dedicated processor, a portion of a processor, a virtual processor, a portion of a virtual processor, a portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic.

In an example, the computing device may be a computer-program product programmed for providing the optimized route between the departure location and the destination location. In another example, the computing device may be a computer readable medium on which program code sections of a computer program are saved, the program code sections being loadable into and/or executable in a system to make the system execute the steps for performing the said purpose. The computing device may be incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments, the computing device can be implemented in a single chip.

In one embodiment, the computing device includes a communication mechanism such as a bus for passing information among the components of the computing device. The computing device includes one or more processing units and a memory unit. Generally, the memory unit is communicatively coupled to the one or more processing units. Hereinafter, the one or more processing units are simply referred to as processor, and the memory unit is simply referred to as memory. Herein, in particular, the processor has connectivity to the bus to execute instructions and process information stored in the memory. The processor may include one or more processing cores with each core configured to perform independently. A multi-core processor enables multiprocessing within a single physical package. Examples of a multi-core processor include two, four, eight, or greater numbers of processing cores. Alternatively, or in addition, the processor may include one or more microprocessors configured in tandem via the bus to enable independent execution of instructions, pipelining, and multithreading. The processor may also be accompanied by one or more specialized components to perform certain processing functions and tasks such as one or more digital signal processors (DSP), or one or more application-specific integrated circuits (ASIC). A DSP typically is configured to process real-world signals (e.g., sound) in real time independently of the processor. Similarly, an ASIC can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

As used herein, the term “processor” refers to a computational element that is operable to respond to and processes instructions that drive the system. Optionally, the processor includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the term “processor” may refer to one or more individual processors, processing devices and various elements associated with a processing device that may be shared by other processing devices. Additionally, the one or more individual processors, processing devices and elements are arranged in various architectures for responding to and processing the instructions that drive the system.

The processor and accompanying components have connectivity to the memory via the bus. The memory includes both dynamic memory (e.g., RAM, magnetic disk, writable optical disk, etc.) and static memory (e.g., ROM, CD-ROM, etc.) for storing executable instructions that when executed perform the method steps described herein for decentralized auditing of the blockchain network. In particular, the memory includes a module arrangement (or a module) to perform steps for decentralized auditing of the blockchain network. The memory also stores the data associated with or generated by the execution of the inventive steps.

Herein, the memory may be volatile memory and/or non-volatile memory. The memory may be coupled for communication with the processing unit. The processing unit may execute instructions and/or code stored in the memory. A variety of computer-readable storage media may be stored in and accessed from the memory. The memory may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like.

In some implementations, the instruction sets and subroutines of the dynamic routing unit 100, which may be stored on storage device, such as storage device coupled to computer, may be executed by one or more processors and one or more memory architectures included within computer. In some implementations, one or more of storage devices may include but are not limited to: hard disk drives; flash drives, tape drives; optical drives; RAID arrays; random access memories (RAM); and read-only memories (ROM). Examples of user devices (and/or computer) may include, but are not limited to, a personal computer, a laptop computer, a smart/data-enabled, cellular phone, a notebook computer, a tablet, a server, a television, a smart television, a media capturing device, and a dedicated network device.

In some implementations, the computing device may include a data store, such as a database (e.g., relational database, object-oriented database, triple store database, etc.) and may be located within any suitable memory location, such as storage device coupled to computer. In some implementations, data, metadata, information, etc. described throughout the present disclosure may be stored in the data store. In some implementations, computer may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, the dynamic routing unit 100 may be a component of the data store, a standalone application that interfaces with the above noted data store and/or an applet/application that is accessed via client applications. In some implementations, the above noted data store may be, in whole or in part, distributed in a cloud computing topology. In this way, computer and storage device may refer to multiple devices, which may also be distributed throughout the network.

In some implementations, the computing device may execute an application for providing the optimized route between the departure location and the destination location, as described later in the description. In some implementations, the dynamic routing unit 100 and/or application may be accessed via one or more of client applications. In some implementations, the dynamic routing unit 100 may be a standalone application, or may be an applet/application/script/extension that may interact with and/or be executed within application a component of application and/or one or more of client applications. In some implementations, application may be a standalone application, or may be an applet/application/script/extension that may interact with and/or be executed within the dynamic routing unit 100, a component of the dynamic routing unit 100, and/or one or more of client applications. In some implementations, one or more of client applications may be a standalone application, or may be an applet/application/script/extension that may interact with and/or be executed within and/or be a component of the dynamic routing unit 100 and/or application. Examples of client applications may include, but are not limited to, a standard and/or mobile web browser, an email application (e.g., an email client application), a textual and/or a graphical user interface, a customized web browser, a plugin, an Application Programming Interface (API), or a custom application. The instruction sets and subroutines of client applications which may be stored on storage devices coupled to user devices may be executed by one or more processors and one or more memory architectures incorporated into user devices.

In some implementations, one or more of client applications may effectuate some or all of the functionality of the dynamic routing unit 100 (and vice versa). Accordingly, in some implementations, the dynamic routing unit 100 may be a purely server-side application, a purely client-side application, or a hybrid server-side/client-side application that is cooperatively executed by one or more of client applications and/or the dynamic routing unit 100.

In some implementations, one or more of client applications may effectuate some or all of the functionality of application (and vice versa). Accordingly, in some implementations, application may be a purely server-side application, a purely client-side application, or a hybrid server-side/client-side application that is cooperatively executed by one or more of client applications and/or application. As one or more of client applications the dynamic routing unit 100, and application taken singly or in any combination, may effectuate some or all of the same functionality, any description of effectuating such functionality via one or more of client applications the dynamic routing unit 100, application or combination thereof, and any described interaction(s) between one or more of client applications the dynamic routing unit 100, application or combination thereof to effectuate such functionality, should be taken as an example only and not to limit the scope of the disclosure.

In accordance with various aspects of the disclosure, the automated dynamic routing unit 100 may be implemented in any suitable vehicle 800. Although, in the present disclosure, the vehicle has been generally described as an automobile 802, the invention is not limited to automobile applications (the navigation system described herein may be utilized for boats 808, bicycles 804, aerial vehicles 806 and the like or activities as hiking 720). The vehicle 800 preferably includes an onboard vehicle navigation system that provides navigation instructions to the driver of vehicle, where such navigation instructions direct the operator to drive along a proposed route from a desired source location to a desired destination location. In practice, the vehicle navigation system may be incorporated into an otherwise conventional onboard vehicle computer system. In present aspects, the dynamic routing unit 100 may be implemented as a module of the vehicle navigation system. The dynamic routing unit 100 may support the vehicle navigation system that leverages a GPS system to obtain accurate position data for the vehicle. In this regard, GPS satellites may communicate, via links, with a conventional GPS receiver located at the vehicle 800. The operation of GPS systems is known to those skilled in the art, and such known features will not be described herein. Alternatively (or additionally), the vehicle navigation system may utilize positioning data provided by a cellular telecommunication network or any appropriate locating system. In certain implementations, the vehicle navigation system may utilize offline maps which may be stored in the memory; for example, for use when the vehicle navigation system may not be able to connect to online source for downloading maps. Further, the vehicle navigation system may continue to update offline maps when the online source may be available.

In an embodiment variant, referring to FIG. 1, the automated dynamic routing unit 100 includes a routing interface unit 110. The routing interface unit 110 is implemented for receiving a destination input 1121. Herein, the destination input 1121 may be in the form of an address, or a location pushpin, that the user may wish to reach. The routing interface unit 110 allows the user 700 to enter data and/or control the functions and features of the dynamic routing unit 100. For example, the user 700 can manipulate the routing interface unit 110 to enter a departure location 1221 and a destination location 1222 for the vehicle 700 or his own route e.g. as a pedestrian or hiker 720, where the departure location 1221 and destination location 1222 are utilized by the dynamic routing unit 100 for purposes of route generation. If the desired departure location 1221 corresponds to a current vehicle location, then the user need not enter the departure location 1221 if the dynamic routing unit 100 includes a means for determining current vehicle position location. Alternatively (or additionally), the vehicle navigation system may rely on the user to enter the current location (e.g., an address), and the vehicle navigation system need not determine the real-time position of vehicle. The routing interface unit 110 may be realized using any conventional device or structure, including, without limitation: a keyboard or keypad; a touch screen (which may be incorporated into display element); a voice recognition system; a cursor control device; a joystick or knob; or the like. It should be appreciated that the routing interface unit 110 and any corresponding logical elements, individually or in combination, are example means for obtaining a departure location 1221 utilized by the dynamic routing unit 100, and example means for obtaining a destination location 1222 utilized by the dynamic routing unit 100.

The automated dynamic routing unit 100 further includes a routing generator 120 for determining one or more routes 122 between the source and the destination. In particular, the routing generator 120 generates one or more routes 1201 between the departure location 1221 and the destination location 1222 e.g. using available location information from a database (not shown) or the like. Such database may include data to calculate routes, provide directions, provide location information, and the like. For example, the database may include geographical or topological map data, road data, waterway data, railway data, lodging information (e.g., campgrounds, motor parks, or hotels), tourist destinations, retail store information (e.g., gas stations, grocery stores, laundromats, or shopping centers), and scenic destinations. In accordance with present embodiments, the database may also include safety metrics or other safety data related to a transportation structure. In this description, a transportation structure may include structures such as roads, bridges, tunnels, overpasses, mountain passes, and the like. Safety metrics or other safety data may include inspection ratings, user feedback ratings, accident metrics, traffic congestion, weather hazards (e.g., risk of mudslides, rock falls, or wash outs), or condition of a transportation structure. Such database may be implemented as a relational database, a centralized database, a distributed database, an object oriented database, or a flat database in various embodiments. In some embodiments, the database may include data that is periodically or regularly updated, mirrored, synchronized, replicated, or otherwise provided by an external data source (e.g., map generation service). In some examples, the generator unit 120 may perform activities, such as preparing a travel itinerary, considering travel preferences, obtaining a map related to a route, and obtaining directions to a destination. The user may be presented one or more questions with relevant options for answers using user-interface elements, such as drop down lists, check boxes, radio buttons, text input fields, or the like. The user-interface may be a part of the embedded routing interface unit 110, and be implemented using a variety of programming languages or programming methods, such as HTML, VBScript, JavaScript, XML, XSLT, AJAX, Java, and Swing. In some examples, a routing generator 120 may have a limited storage that stores the locations and the routes the user may have travelled frequently and/or occasionally. The routing generator 120 may use the stored map information to generate one or more proposed routes 1201 between the source location and the destination location.

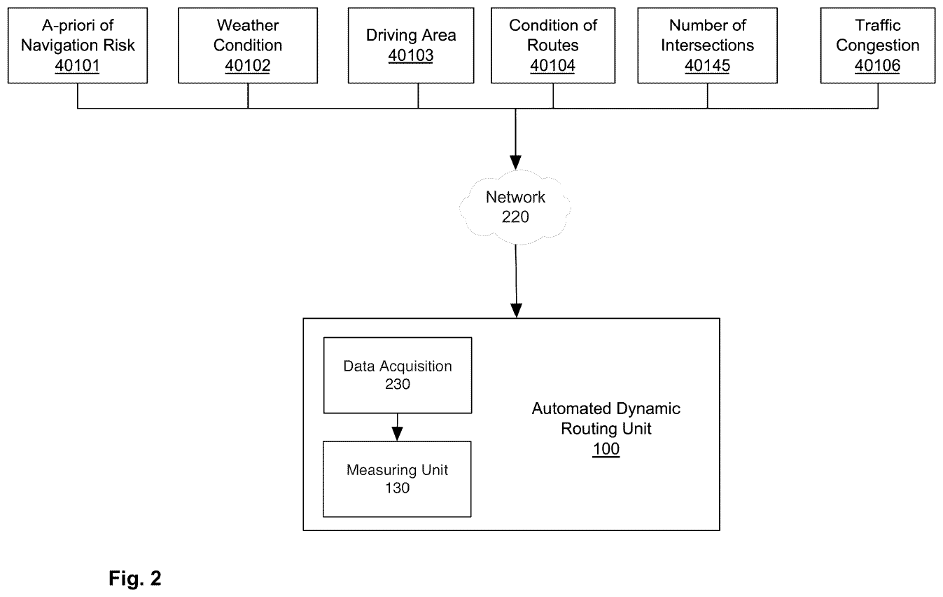

The automated dynamic routing unit 100 further includes a measuring unit 130 dynamically determining, measuring and forecasting for each of the generated routes 1201 time- and location dependent measured exposure values 1301 given by measured and forecasted time- and location dependent probability values quantitatively measuring the probability for occurrences of impacting accident events 900/910/920 along the one or more routes 1201. Referring to FIG. 2, as shown, the route parameters 4010 comprises at least a-priori of navigation risk parameters 40101, weather condition parameters 40102, driving area parameters 40103, condition parameters 40104, number of intersections 40105, traffic congestion parameters 40106 and/or further risk-exposer related measure parameters 40107 along the routes 1201.

Herein, the a-priori of navigation risk parameters 40101 associated with the routes 1201 are related to inherent risk along a given route 1201. Such a-priori of navigation risk 40101 may be due to accidents along the given route. Priori probability generation is often done through deductive reasoning. This is so because, in order to determine the number of the possible outcome of any occurrence, logic must be applied. The a-priori of navigation risk parameters may be based on prior information when making a conclusion, as may be determined from statistical accident rate data, real-time accident event data, accident severity data, and other accident related data corresponding to the particular route sections under consideration. In a practical embodiment, such data may be obtained, accessed, or derived from various public or private sources, including, without limitation: law enforcement bodies; public transportation agencies, such as state departments of transportation; National Highway Traffic Safety Administration (“NHTSA”); Insurance Institute for Highway Safety (“IIHS”); or American Automobile Association (“AAA”). In a practical embodiment, route sections having relatively high accident rates will be less favored than route sections having relatively low accident rates. The weather condition parameters 40102 along the routes 1201 comprises information about weather hazards such as, risk of roadblocks due to mudslides, rock falls, or wash outs due to rains, and/or snowfall. Further, the weather condition parameters 40102 can e.g. also comprise (i) #_of stops, (ii) #_sharp curves, (iii) #_sharp_curves in combination of intersections, #sharp_curves in combination of downhill/uphill road segments (and all the associated intensive measures i.e. #_context_type/length of the route expressed in kilometers), (iv) percentage of kilometers for each road category (we consider 5 types going from the fastest-high volume roads—type 1—to the slowest-small traffic volume roads—type 5, (v) percentage of kilometers with 1, 2, 3 or more lanes, (vi) percentage of kilometers uphill and downhill, and/or (vii) percentage of kilometers travelled with possible sun glare effect, etc. The inventive system thus allows to keep the focus not only on the features that are expected to impact the accident probability but also to the ones that are expected to also impact the CO₂ footprint (e.g. (i/ii/vi). The driving area parameter 40103 along the routes 1201 comprises statistical and/or real-time information indicative of safety-related characteristics of the particular route sections under consideration, including road geometry data, the total number of lanes, the number of carpool lanes, the width of individual lanes, the number or severity of curves in a road segment, the number of bridges, tunnels, or elevated sections in a road segment, or the number of on/off ramps in a road segment, city area, school area, wildlife crossing areas, speed breakers, toll plazas and the like. The condition parameters 40104 of the routes 1201 comprises road composition data, the age of the road segments, the composition of the road surface, e.g., asphalt, concrete, rubberized, gravel, dirt, or the like, whether a given road segment includes texturing for the prevention of hydroplaning, whether a given road segment is susceptible to rain, snow, or ice, or the number of potholes, cracks, or other surface defects in a road segment. The number of intersections 40105 along the routes 1201 is also considered which may be based on cartographic sources, which are readily available and currently used with existing vehicle navigation systems, while some vendors offer software applications that analyze road topologies. The traffic congestion parameters 40106 along the routes 1201 can e.g. comprise real-time traffic congestion data in an attempt to guide the vehicle away from traffic jams that may increase a risk of collision. Further, the parameters 40106 can e.g. also comprise constructions sites and/or road closure and/or car accidents. For example, cities have higher traffic congestions as compared to country sides. Other risk parameters not described here are contemplated herein.

In some embodiments, the vehicle embedded, risk-based automated dynamic routing unit 100 further comprises a data acquisition unit 230 for continuously acquiring the route parameters 4010 along the routes 1201. The data acquisition unit 230 may acquire the route parameters 4010 using a data transmission network 220. The network 220 may include local-area networks (LAN), wide-area networks (WAN), wireless networks (e.g., 802.11 or cellular network), the Public Switched Telephone Network (PSTN) network, ad hoc networks, personal area networks (e.g., Bluetooth), or other combinations or permutations of network protocols and network types. The network 220 may include a single local area network (LAN) or wide-area network (WAN), or combinations of LANs or WANs, such as the Internet. The various devices coupled to the network 220 may be coupled to the network 220 via one or more wired or wireless connections. The wireless connections may be short-range (e.g., inductive telemetry or Bluetooth) or longer-range (e.g., IEEE 802.11, IEEE 802.x wireless communication, 3G, 4G, 5G or cellular wireless) protocols. Herein, the risk parameters 202-212 may be acquired from respective data sources, including, but not limited to, the database as described in the preceding paragraphs, using communication channels as provided via the network 220.

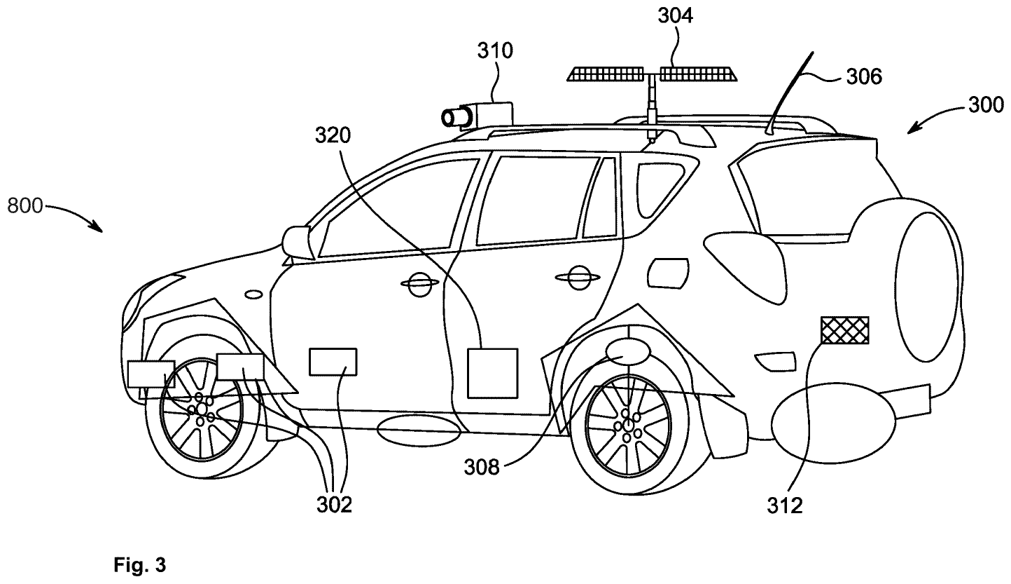

In additional embodiments, the data acquisition unit 230 may further acquire vehicle telematics data for directly determining the route parameters 4010, in real-time. Referring to FIG. 3, as discussed, the present dynamic routing unit 100 can e.g. be implemented for motor vehicles (generally represented by the reference numeral 800). For the purposes of the present disclosure, the motor vehicle 800 (also simply referred to as “vehicle” or “an automobile”) may be any suitable type of vehicle including, but not limited to, motor vehicles (including internal combustion engine based cars, electric cars or hybrid cars), buses, motorcycles, off-road vehicles, light trucks and regular trucks, autonomous vehicles without any limitations. In some examples, the vehicle 800 may be provided with ADAS features. Herein, Advanced driver-assistance systems (ADAS) are groups of electronic technologies that assist drivers in driving and parking functions. ADAS use automated technology, such as sensors and cameras, to detect nearby obstacles or driver errors, and respond accordingly. Primarily, motor vehicles with ADAS features may detect certain objects, do basic classification, alert the driver of hazardous road conditions and, in some cases, automatically decelerate or stop the vehicle. By connecting the ADAS to a telematics system (as will be discussed later in the disclosure), it is possible to capture the vehicle events within a fleet system and implement a driver-monitoring program. ADAS features may include, but are not limited to, adaptive cruise control, glare free high beam and pixel light, anti-lock braking system, automatic parking, automotive navigation system, automotive night vision, blind spot detection system, collision avoidance system, crosswind stabilization, intelligent speed adaptation, lane centering, lane departure warning system, lane change assistance system, surround view system, tire pressure monitoring, etc.

The vehicle 800 may be provided with vehicle-based telematics circuit 300, for sensing environmental parameters during operation of the motor vehicle 800. The telematics circuit 300 may include exteroceptive sensors or measuring devices which may, for example, include at least radar devices 302 for monitoring surrounding of the motor vehicle 10 and/or LIDAR devices 304 for monitoring surrounding of the motor vehicle 800 and/or global positioning systems 306 or vehicle tracking devices for measuring positioning parameters of the motor vehicle 800 and/or odometrical devices 308 for complementing and improving the positioning parameters measured by the global positioning systems 308 or vehicle tracking devices and/or computer vision devices 310 or video cameras for monitoring the surrounding of the motor vehicle 10 and/or ultrasonic sensors 312 for measuring the position of objects close to the motor vehicle 800. The telematics circuit 300 may also include proprioceptive sensors (generally represented by reference numeral 320) or measuring devices for sensing operating parameters of the motor vehicles 800 may include motor speed and/or wheel load and/or heading and/or battery status of the motor vehicles 800, and the like. The telematics circuit 300 may determine real-time road conditions, weather conditions and the like to determine the route parameters 4010, in real-time.

Referring back to FIG. 1, the measuring unit 130 provides an aggregated exposure score 1302 for each of the routes 1201 based on the route parameters 4010 and/or the user-specific parameters 790. The measuring unit 130 may assign individual risk score to a number of the routes 1201 identified by the routing generator 120. The exposure score may be any quantity, such as a numerical score, that is indicative of the relative safety level for a particular route. For example, a statistically safe route section having an extremely low accident rate and an extremely low crime rate may be assigned a relatively low risk score (such as zero), while a statistically unsafe route section having a high accident rate, a high crime rate, or uncharacteristically poor surface conditions may be assigned a relatively high risk score. In particular, the aggregated exposure score 1302 for each of the routes 1201 may be generated by assigning weights to each of the considered route parameters 4010 and/or user-specific parameters 790, like the a-priori of navigation risk parameters 40101 associated with the routes 1201, the weather condition parameters 40102 along the routes 1201, the driving area parameters 40103 along the routes 1201, the condition parameters 40104 of the routes 1201, the number of intersections 40105 along the routes 1201, the traffic congestion parameters 40106, and the further risk-exposer related measure parameters 40107 along the routes 1201. The exposure score 1302 may fall within any suitable range, and different route parameters 4010 may have higher or lower ranges depending upon their relative weights. Herein, the weights may be provided by the user or may be derived from related information. For example, the type of travel (e.g., business or pleasure), the participants in the travel (e.g., a single person or a family of five), the destination location, the beginning location, the mode of travel, or other characteristics of the travelers, the transportation used, or the locations visited or traveled through may be used to derive the weights of the various route parameters 4010.

In case, any of the one or more routes 1201 may have multiple route segments with different exposure scores 1301 (e.g. different time- and location-dependent measured exposure values 1301), an overall exposure score 1302 for that route can be aggregated using any number of techniques, depending upon the implementation of the vehicle navigation system. For example, the overall exposure score 1302 for a potential route may be a simple sum or a weighted sum of the individual time- and location-dependent measured exposure values 1301 for multiple route segments for that route 1201. Alternatively, the overall safety factor for a potential route may be generated using a more complex formula or mathematical expression that considers some or all of the time- and location-dependent measured exposure values 1301 for multiple route segments for that route.

The automated dynamic routing unit 100 further includes a route selector 140 for determining an optimized route 1401 among the one or more routes 1201 based on at least one of the navigational risks and/or the exposure scores 1301/1302. Herein, the optimized route 1401 is determined to be the route from the one or more routes 1201 with a lowest aggregated exposure score value 1302 among the one or more routes 1201 that were considered, to favor relatively safe route over relatively unsafe routes. The route selector 140 is further implemented for recommending the safest route on the routing interface unit 110. For this purpose, the embedded routing interface unit 110 may incorporate one or more of display device and speaker device which may be configured in accordance with conventional vehicle navigation systems to enable onboard interaction with the user. Display device may be a Liquid Crystal Display (LCD), plasma, Cathode Ray Tube (CRT), or head-up display, which may or may not be utilized for other vehicle functions. In accordance with known techniques, the routing interface unit 110 can provide rendering control signals to display device to cause display device to determine the optimized route 1401, and further render maps, alternate routes, roads, navigation direction arrows, and other graphical devices as necessary to support the function of the dynamic routing unit 100. Further, the speaker device may be devoted to a vehicle navigation system, or it may be realized as part of the audio system of the vehicle, or it may be realized as part of another system or subsystem of the vehicle. Briefly, the speaker device may receive audio signals from the dynamic routing unit 100, where such audio signals convey navigation instructions, user prompts, warning signals, and other audible signals as necessary to support the function of the dynamic routing unit 100.

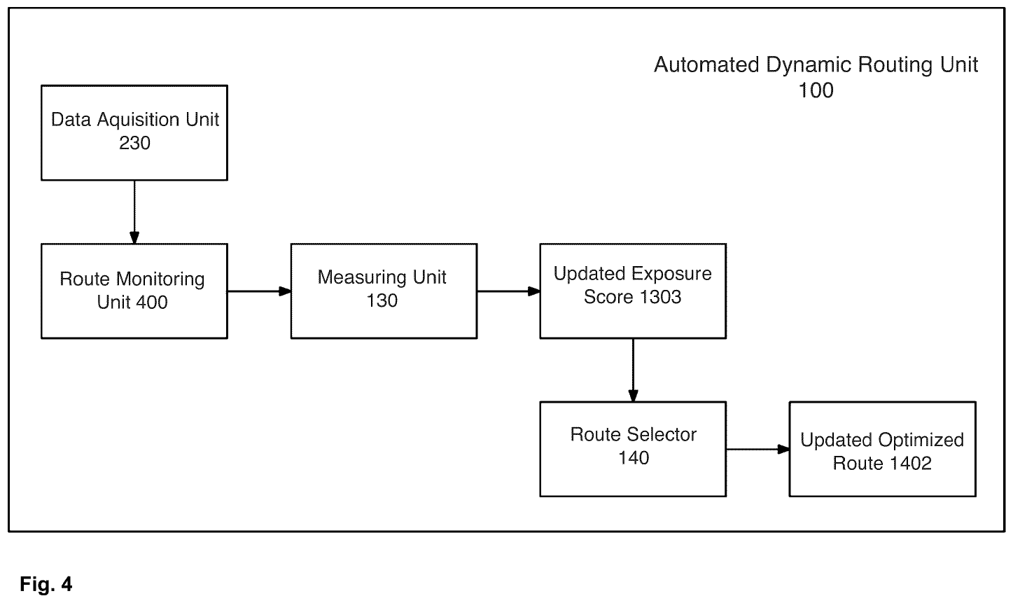

Referring to FIG. 4, as shown, in some embodiments, the automated dynamic routing unit 100 further comprises a route monitoring unit 400 for continuously monitoring the route parameters 4010 and/or the user-specific parameters 790 along the routes 1201 to determine change in the route parameters 4010 along the routes 1201. The route monitoring unit 400 may perform continuous comparisons between a previously received data about the route parameters 4010 and a latest received information about the route parameters 4010, and check if there is any change in any of the route parameters 4010 for a given route 1201. Such change may be due to change in conditions, like change in weather along the given route 1201. For example, a given route may start receiving rains and thus, the risk due to weather parameter may increase. As may be appreciated that if a change is determined in any of the route parameters 4010 for a given route 1201, the corresponding determined exposure scores 1301/1302 for the given route 1201 may also change, and thereby a given route 1201 which may have been determined to be the optimized route 1401 may no longer be the most optimized route. Therefore, in response to changes in the route parameters 4010 for the optimized route 1401 and the one or more routes 1201, the route monitoring unit 400 communicates the changes to the measuring unit 130. Then, the measuring unit 130 dynamically re-determines one or more of the time- and location-dependent measured exposure values 130 along one or more routes 1201 based on the changed route parameters 4010/40101-40107) and provide a dynamically updated aggregated exposure score measure 1303 for the routes 1201 concerned, wherein, in response to at least one of changed route parameters 4010/40101-4010 and the updated exposure score measures 1303 for each of the routes 1201, the route selector 140 determines a dynamically updated optimized route 1402 among the one or more routes 1201.

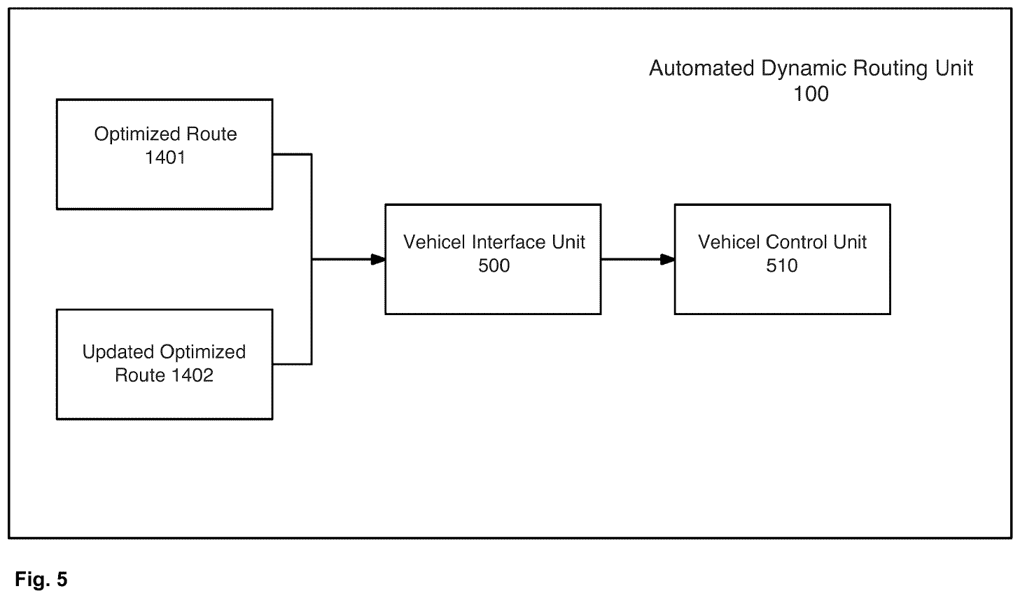

Referring to FIG. 5, in some embodiments, the automated dynamic routing unit 100 further comprises an automobile interface unit 500 to communicate at least one of a notification or control instructions to an automobile control unit 510 to display the optimized route 1401 or the updated optimized route 1402 or control the automobile 800 to navigate on the optimal route 1401 or the updated optimized route 1402. It is important to note, that the automated dynamic routing unit 100 can e.g. either be embedded in a vehicle 800. However, the automated dynamic routing unit 100 can e.g. also be realized as an electronic data processing module running and executing as software in the cloud, e.g. accessible by API (Application Programming Interface) from client devices (e.g. used associated with vehicles or pedestrians etc.) that would like to receive automatically generated recommendations or electronic steering or alarm signaling for going to departure point A to destination point B. In addition it should be noted that the inventive system can also be realized as an embodiment variant, in which the vehicle(s) that might use the automated dynamic routing unit 100 e.g. act as sensors (e.g. smart vehicles or otherwise connected vehicles) to collect updated, real-time measuring data on the road conditions (e.g. asphalt condition, traffic congestions) and communicate this measuring data to a centralized data processing unit that can e.g. use the latter to up-to-date features in the dynamic routing optimization processing problem.

In one embodiment, the automobile interface unit 500 may generate the notification or control instructions based upon the exposure score 1302/1303, or determination of the optimized route 1401 or the updated optimized route 1402. Such notification may be a virtual navigation map or an audible, visual, or haptic alert. For example, the virtual navigation map may visually depict the optimized route 1401 or the updated optimized route 1402. The virtual navigation map may include graphic elements depicting exposure scores 1301 and/or 1302 for the optimized route 1401 or the updated optimized route 1402. The virtual navigation map may be in the form of a heat map. The generated notification may further be transferred to an electronic device (e.g., mobile device, an on-board computer, wearable electronics including an augmented reality appliance, and a navigator) associated with a vehicle, user or passenger of a vehicle, pedestrian, bicyclist, and the likes to facilitate routing or re-routing that avoids traversing the route based upon exposure scores 1301 and/or 1302, via wireless communication or data transmission over one or more radio links or wireless communication channels. The electronic devices may receive such notifications when approaching the hazardous route; for example, a route having exposure scores 1301 and/or 1302 exceeding a predetermined threshold. The notification may indicate that potentially hazardous traffic conditions such as merging traffic, abnormal traffic flow, reduced number of lanes (e.g., 3 lanes being condensed to 2 lanes), road construction, and suboptimal road surface resulting from inclement weather conditions are on the route ahead. In another embodiment, the automobile interface unit 500 may control the automobile 800 to navigate on the optimized route 1401 or the updated optimized route 1402. As discussed, the automobile 800 may be provided with ADAS features. In some examples, the automobile 800 may be an autonomous vehicle (self-driving vehicle). In such a case, the automobile interface unit 500 may control the automobile to follow the optimized route 1401 or the updated optimized route 1402. It may be appreciated that in the present embodiments, the updated optimized route 1402 is prioritized over the previously determined optimized route 1401, as the updated optimized route 1402 is updated as per the change in the route parameters 4010.

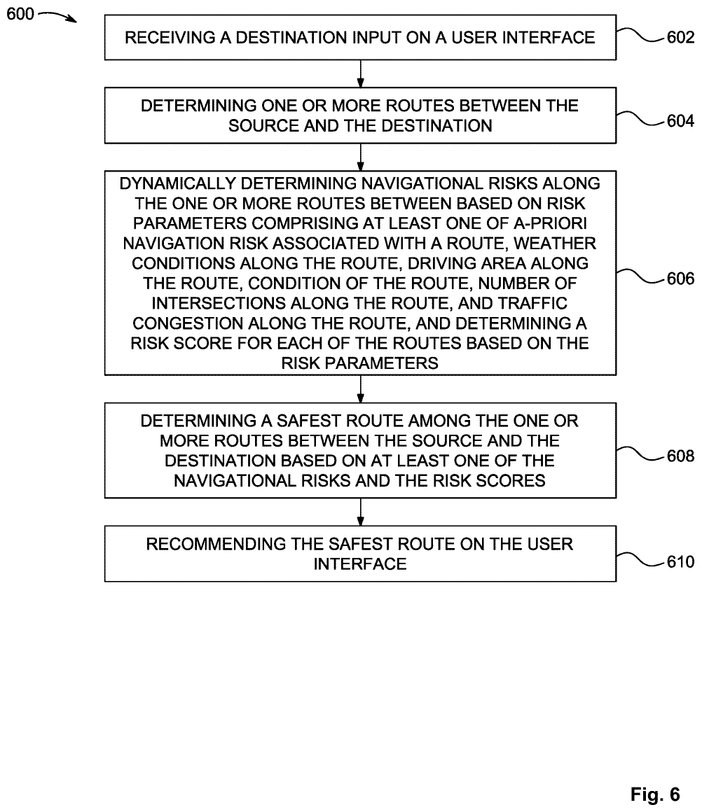

FIG. 6 is a flow diagram illustrating an automated dynamic routing method 600 for providing an optimized route between a departure location 1221 and a destination location 1222, comprising the steps of (i) receiving destination input parameters 112/1121 of a destination location 1221 and/or departure location input parameters 112/1122 of a departure location 1222 by a routing interface 110, (ii) generating one or more routes 1201 between the departure location 1221 and the destination location 1222 by a routing generator 120, (iii) dynamically measuring and forecasting, by means of a measuring unit 130, for each of the generated routes 1201 time- and location dependent measured exposure values 1301 given by measured and forecasted time- and location dependent probability values quantitatively measuring the probability for occurrences of impacting accident events 900/910/920 along the one or more routes 1201, the impacting accident events 900/910/920 occurring temporal and spacial coincidentally at a respective location of the vehicle 800 and/or user 700 traveling along a route 1201, wherein the measuring unit 130 measures and forecasts said time- and location dependent probability values 1301 by processing measured route parameters 40101 associated with the generated routes 1201, wherein the measured route parameters 40101 comprise at least a-priori of navigation risk parameters 40101, weather condition parameters 40102, driving area parameters 40103, condition parameters 40104, number of intersections 40105, traffic congestion parameters 40106 and/or further risk-exposer related measure parameters 40107 along the routes 1201, (iv) generating, by means of the measuring unit 130, an aggregated exposure score measure 1302 for each of the routes 1201 based on the measured route parameters 4010/40101-40107 and/or the time- and location dependent exposure values 1301, (v) selecting, by means of a route selector 140, the most optimized route 1401 among the generated routes 1201 based on the aggregated exposure score measure 1302 values and/or the measured route parameters 4010/40101-40107 and/or the time- and location dependent exposure values 1301 and/or user-specific parameter values, and (vi) providing the selected optimized route 1401 as output on the routing interface unit 110.

It may be appreciated that the execution of the steps of the method 600 may be performed by components of the automated dynamic routing unit 100, as described above. In general, various embodiments and variants disclosed above apply mutatis mutandis to the method 600.

Notably, once the optimized route 1401/1402 can e.g. be identified and accessed, incorporating the optimized route 1401/1402 into a route planning strategy by vehicle navigation system is conceptually straightforward. Herein, instead of focusing on the mitigation of risky situations, such a risk-minimizing routing solution, the present dynamic routing unit can proactively work on prevention, and thus enable the drivers to enjoy safer trips by minimizing the probability of encountering risky situations. The present dynamic routing unit minimizes both a-priori and in real time insurance risks along a route like hazardous weather conditions, driving area, dangerous roads (multiple connotations of danger) and traffic congestion. The present dynamic routing unit may further be used for generating an optimized dynamic risk-transfer cover using mobile telematics data capturing, etc. The present dynamic routing unit may not only be limited to road based vehicle safety but also be applicable for maritime risk routing, air traffic routing and the like, with changed or appropriate risk parameters.

In some situations, the user or the driver 700 may prefer to use a route 122 that may be lesser safer than the optimized route 1401 suggested by the dynamic routing interface unit. Such events may lead to consideration for increase in insurance premiums which may also depend upon various factors such as driving history 7903, age 7901, gender 7904, marital status 7905, number of driving years 7902, and the like.

While various embodiment variants of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

In an even further embodiment variant, the motor vehicle 800 properties are the system component 810 providing the inputs to the routing modeling structure to forecast the navigation behavior of the selected motor vehicle 800. It can e.g. consist of a set of static and dynamic parameters. The static parameters are the ones characterizing e.g. the shape of the motor vehicle (e.g. for ships 808) and its hull, such as length (m), draft (m) or beam (m). The dynamic parameters can be e.g. for ships 808 current surge, heading (in respect to the north direction) and sea waves conditions. All this determines the sailing conditions. For motor vehicle as cars 802 appropriate parameters have to be chosen etc. In the example of the motor vehicle 800 as ship 808, as an example, the wave period experienced by the ship 808, known as wave encounter period is determined as function of the encounter angle, the vessel surge and the wave celerity. Due to adverse conditions and/or the current course, the ship 808 may face dangerous situations that must be captured by the forecast/simulation structure in the definition of a weather routing. In this implementation, the ship 808 properties component can e.g. collect the following parameters: ship length, draft, beam, metacenter height, maximum surge. For other motor vehicle 800, this approach has to be converted appropriately.

In an embodiment variant, the dynamic routing unit 100 and the route generator 120, respectively, can e.g. comprise a routing layer representing the data processing core of the routing system. At this level the waypoints characterizing a route are generated based on a forecast and the derived traveling conditions. The routing problem can e.g. be addressed and solved as a multicriteria path finding structure through a Martins labelling process. At this level, the graph spatial grid G(N,A) with N={1, . . . , n} the finite set of location nodes, and A⊆N×N the finite set of linking edges can e.g. be generated based on the specified departure 1221 and arrival 1222 geographical locations. Starting from the nominal route 122 from origin to destination, a perpendicular to the route multistage grid can be defined. The start and the end locations 1221/1222 represent one node each and along the route 122 new nodes are added to each stage. The graph spatial grid is composed by a finite number of stages where each node of one stage is connected to all the nodes in the next. Finally, the resulting spatial grid can then be cleaned of the edges and nodes where the navigation is not allowed (e.g. for ships 808 depth too low, edge crossing land, etc.). In a variant, the navigation safety criteria can e.g. be used for the definition of navigation constraints to limit the areas where the navigation is allowed and not allowed (by removing the edges involved). For example, all the available routes can be kept in the spatial grid, and the safety/risk criteria are included as discussed below.

In order to generate the optimal path between the source and destination locations 1221/1222, it is necessary to associate to each edge a measure. In this example, this can technically be regarded as a multi-criteria path finding problem, therefore each edge is characterized by a set of 3 measures defining the overall measure for navigating through the selected edge. The 3 criteria used in this setup can e.g. be the following: (i) Travel time: Generation of travel time for traversing the edge based on the current route conditions; Added motor vehicle 800 parameters resulting in external interference, as e.g. for ships 808 ship resistance: Estimate of the added resistance caused by waves and winds. This criterion enables the user to investigate the relation between the fuel consumption and the various route states and directions that the motor vehicle may encounter during the navigation; (iii) Navigation risk: Forecast of the navigation risk based on the route conditions as function of the adverse conditions and motor vehicle 800 properties and configuration. This is executed based on the threshold parameter measuring values for the detection of dangerous and risky conditions.

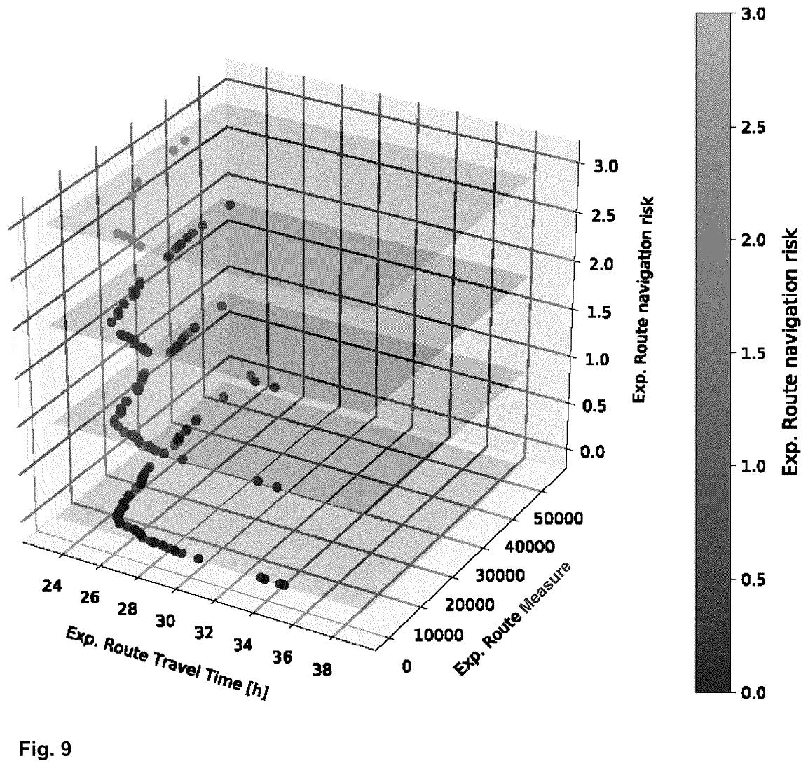

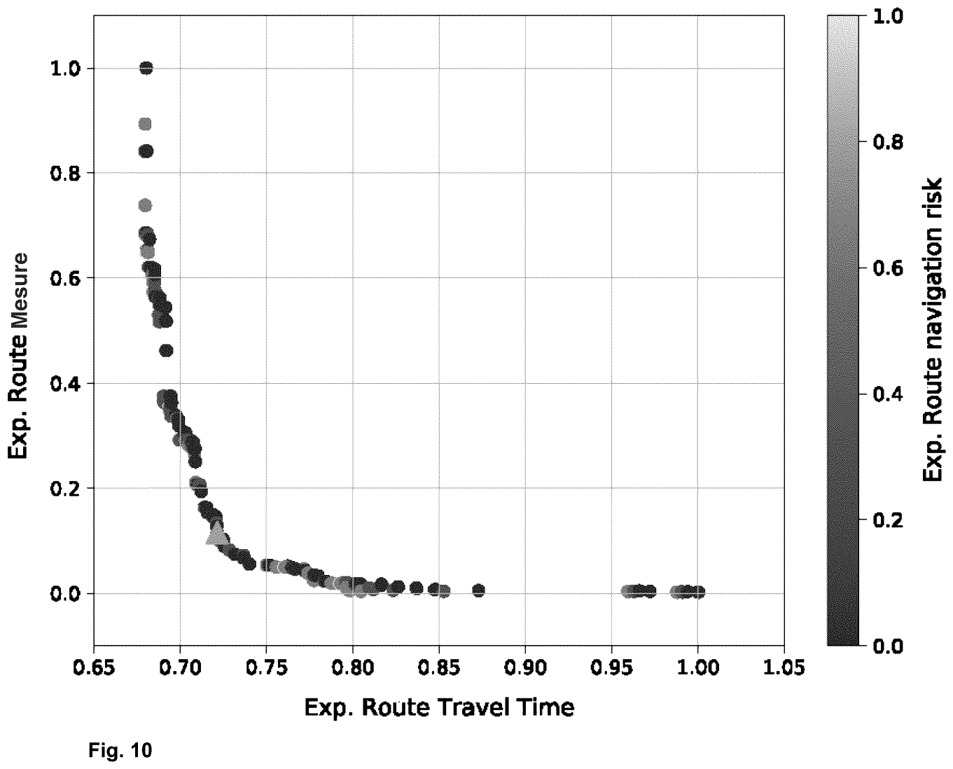

As above, the dynamic routing unit 100 can e.g. be realized as an embodiment variant allowing to provide a trade-off between different criteria to dynamically select the most optimal route 1401/1402 by the route selector 140. This embodiment variant can e.g. comprise a decision layer structure representing the component of the weather routing where a route selector 140 dynamically interacts with the system to select the optimal route/trajectory 1401/1402 that represents the best trade-off among the available candidate routes 1201 generated by the route generator 120. To this aim, e.g. a pareto front can be generated and, for example, further be visualized through a hyper radial visualization. For example, the pareto route solutions 1201 can dynamically be grouped based on the navigation risk. FIG. 9 illustrates a set of Pareto efficient route solutions 1201 generated through a routing process 600 in the selected scenario. Each axis represents a different criterion: x axis—travel time, y axis—navigation added measure and z axis—navigation risk. The generated routes 1201 can e.g. be grouped by appropriate indications by the route selector 140 to select the optimized route 1401/1402. An embodiment variant, shown in FIG. 10, provides a trade-off between different criteria. A set of pareto efficient route solutions 1201 generated by the route generator 120 through the routing process 600 in the selected scenario. The generated routes 1201 are illustrated in the 3-dimension space: x axis—travel time, y axis—navigation added navigation measure and the color domain to identify the routes by risk. The red triangular marker identifies the optimized route 1401/1402 representing the best trade-off solution for the route selector 140.

### REFERENCE LIST

100 Vehicle embedded or mobile-phone based, automated dynamic routing unit
102 Driver/passenger of the vehicle
110 Routing interface
   11101 Persistence Storage
112 Input parameters
   1121 Starting/departure location input parameters
   1122 Destination input parameters
120 Routing generator
   1201 Generated Routes
122 Route traveled
   1221 Departure location
   1222 Destination location
130 Measuring unit/Exposure measuring unit
   1301 Time- and location-dependent measured exposure values
   1302 Aggregated exposure score measure
   1303 Updated exposure score
140 Route selector
   1401 Optimized route
   1402 Updated optimized route
220 Data transmission network
   2200 Cellular mobile network
   2201 Network cells
   2202 Basic cell station
   2203 Satellite data connection
   2204 Data transmission line
230 Data acquisition unit
   2301 Data network interface
300 Vehicle-based telematics circuit
   302 Radar devices
   304 LIDAR devices
   306 Global Positioning Systems (GPS)
   308 Odometrical devices
   310 Computer vision devices
   312 Ultrasonic sensors
   320 Proprioceptive sensors
400 Route monitoring unit
   4010 Route parameters
      40101 A-priori of navigation risk parameters
      40102 Weather condition (environmental condition) parameters
      40103 Driving area parameters
      40104 Condition parameters
      40105 Number of intersections
      40106 Traffic congestion parameter
      40107 Further risk-exposer related measure parameters
500 Vehicle interface unit
510 Vehicle control unit
520 Mobile phone
600 Automated dynamic routing process or method
   602 Step 1
   604 Step 2
   606 Step 3
   608 Step 4
   610 Step 5
700 User
   710 Driver/Passenger
   720 Pedestrian/Hiker
   730 Pilot/Passenger
   740 Diver/Deep sea diver
   760 Mountain Climber
   780 Other route-based outdoor activities
   790 User-specific parameters
      7901 Age
      7902 Driving years
      7903 Driving history
      7904 Gender
      7905 Marital status
800 Vehicle
   802 Motor vehicle/automobile
   804 Bike
   806 Aerial vehicle/aircraft
      8060 Airplane
      8062 air-cushion boat
      8064 Hang Glider/Paraglider/Delta sailor
      8066 Drone
   808 Motor boat/sailing boat/ship etc.
   810 Vehicle parameters
900 Optimized event
   910 Physical accident event associated with a route
   920 CO₂ emission event and/or CO₂ output event associated with a route

1. A vehicle embedded or mobile-phone-based, automated dynamic routing unit associated with a vehicle and/or a user along a route traveled, the dynamic routing unit providing an optimized route between a departure location and a destination location, the automated dynamic routing unit comprising:
processing circuitry configured to implement
a routing interface for receiving destination input parameters of a destination location and/or departure location input parameters of a departure location, and wherein the automated dynamic routing unit comprises a routing generator for generating a plurality of routes between the departure location and the destination location,
a measuring unit dynamically measuring and forecasting for each of the generated routes time- and location dependent measured exposure values given by measured and forecasted time- and location dependent probability values quantitatively measuring the probability for occurrences of impacting accident events along the routes, the impacting accident events occurring temporal and spacial coincidentally at a forecasted location of the vehicle or user traveling along a route, and the measuring unit measuring and forecasting said time- and location dependent probability values by processing measured route parameters associated with the generated routes and/or user-specific parameters, the measured route parameters comprising at least a-priori navigation risk parameters related inherent risks along a given route at least being based on statistical accident rate data and/or real-time accident event data and/or accident severity data and/or accident related data corresponding to particular route sections, weather condition parameters, driving area parameters, condition parameters of the routes at least comprising comprises road composition data and/or the age of the road segments and/or the composition of the road surface, number of intersections and/or traffic congestion parameters, wherein the automated dynamic routing unit comprises a data acquisition unit for continuously acquiring route and/or user-specific parameters along the routes by collecting measured telematics data via sensors embedded in a cellular smartphone or embedded in mobile telematics devices associated with the vehicle, the sensors at least comprising a GPS sensor, and, wherein the measuring unit provides an aggregated exposure score measure for each of the routes based on the measured time- and location dependent exposure values, and
a route selector for selecting the a most optimized route among the routes based on at least the time- and location dependent measured exposure values along each route and/or the aggregated exposure score measures of the routes, and providing the selected optimized route as output on the embedded routing interface unit, wherein the dynamic routing unit comprises a routing layer as data processing core, wherein waypoints characterizing a route are generated based on a forecast and derived traveling conditions providing a spatial multistage grid by generating a finite set of location nodes and a finite set of linking edges based on specified departure and arrival geographic locations, the departure and arrival geographic locations specifying one node each and along the route and adding new nodes for each stage, wherein a perpendicular to the multistage grid is defined starting from the nominal route from the specified departure and arrival geographic locations and the multistage grid is composed by a finite number of stages where each node of one stage is connected to all the nodes in the next stage,
wherein to generate the optimal path between the source and destination locations, each edge is associated with an overall measure for navigating through a selected edge and a pareto front is generated, wherein a set of pareto efficient route solutions is generated through a routing process in a selected scenario, and wherein the pareto route solutions are dynamically grouped based on the navigation risk to select the optimized route by the route selector.

2. The automated dynamic routing unit according to claim 1, wherein the most optimized route is the route having a minimal measured aggregated exposure score value indicating the route with the lowest measured and forecasted probability for a physical impact to the vehicle and/or user caused by an occurring accident event.

3. The automated dynamic routing unit according to claim 1, wherein, for selecting the most optimized route, the route selector comprises a trigger for selecting the most optimized route among the routes by using the values of the aggregated exposure score measure of the routes, wherein the most optimized route is triggered by the route having the smallest aggregated exposure score measure value, or by the route having the smallest maximum value of a time- and location dependent measured exposure values along each route.

4. The automated dynamic routing unit according to claim 1, wherein the measuring unit provides the aggregated exposure score measure for each of the routes by aggregation of the time- and location dependent exposure values along each route.

5. The automated dynamic routing unit according to claim 1, wherein the automated dynamic routing unit comprises a data acquisition unit for continuously and dynamically acquiring and/or monitoring measured route parameters along the routes, wherein actual route parameters are, at least partially, measured by one or more measuring devices and/or sensors associated with the vehicle and/or the mobile device and/or the user and/or external contextual measuring systems associable with the routes.

6. The automated dynamic routing unit according to claim 1, wherein the automated dynamic routing unit comprises a route monitoring unit for continuously monitoring the route parameters along the routes to detect and measure changes in the measured values of the route parameters along the routes, wherein in response to changes in at least one of the route parameters, the route monitoring unit communicates the changes to the measuring unit, wherein the measuring unit dynamically re-determines one or more of the time- and location-dependent measured exposure values along one or more routes based on the changed route parameters and provide a dynamically updated aggregated exposure score measure for the routes concerned, wherein, in response to at least one of changed route parameters and the updated exposure score measures for each of the routes, the route selector determines a dynamically updated optimized route among the one or more routes.

7. The automated dynamic routing unit according to claim 1, wherein the automated dynamic routing unit comprises an automobile interface unit to communicate at least one of a notification or control instructions to an automobile control unit to display the optimized route or an updated optimized route.

8. The automated dynamic routing unit according to claim 1, wherein the automated dynamic routing unit comprises an automobile interface unit to communicate at least one of a control instructions or the optimized route to an automobile control unit, the automobile control unit being connected to or comprising an Advanced Driver Assistance System (ADAS) or an autonomous driving system of the vehicle, wherein the optimized route is automatically chosen to be driven by the autonomous driving system or upon selection by the user.

9. An automated dynamic routing method, implemented by processing circuitry of an automated dynamic routing unit, for providing an optimized route between a departure location and a destination location, wherein destination input parameters of a destination location and/or departure location input parameters of a departure location are received via a routing interface implemented by the processing circuitry, and wherein a plurality of routes between the departure location and the destination location is generated by a routing generator, the method comprising:
dynamically measuring and forecasting, by means of a measuring unit implemented by the processing circuitry, for each of the generated routes time- and location dependent measured exposure values given by measured and forecasted time- and location dependent probability values quantitatively measuring the probability for occurrences of impacting accident events along the routes, the impacting accident events occurring temporal and spacial coincidentally at forecasted location of the vehicle and/or user traveling along a route, wherein the measuring unit measures and forecasts said time- and location dependent probability values by processing measured route parameters associated with the generated routes, wherein the measured route parameters comprise at least a-priori navigation risk parameters related inherent risks along a given route at least being based on statistical accident rate data and/or real-time accident event data and/or accident severity data and/or accident related data corresponding to particular route sections, weather condition parameters, driving area parameters, condition parameters of the routes at least comprising comprises road composition data and/or the age of the road segments and/or the composition of the road surface, number of intersections and/or traffic congestion parameters, wherein the automated dynamic routing unit comprises a data acquisition unit for continuously acquiring route and/or user-specific parameters along the routes by collecting measured telematics data via sensors embedded in a cellular smartphone or embedded in mobile telematics devices associated with the vehicle, the sensors at least comprising a GPS sensor,
generating, by means of the measuring unit, an aggregated exposure score measure for each of the routes based on the measured time- and location dependent exposure values,
selecting, by means of a route selector implemented by the processing circuitry, a most optimized route among the generated routes based on the aggregated exposure score measure values and/or the measured route parameters and/or the time- and location dependent exposure values and/or user-specific parameter values, wherein the dynamic routing unit comprises a routing layer as data processing core, wherein waypoints characterizing a route are generated based on a forecast and derived traveling conditions providing a spatial multistage grid by generating a finite set of location nodes and a finite set of linking edges based on specified departure and arrival geographic locations, the departure and arrival geographic locations specifying one node each and along the route and adding new nodes for each stage, wherein a perpendicular to the multistage grid is defined starting from the nominal route from the specified departure and arrival geographic locations and the multistage grid is composed by a finite number of stages where each node of one stage is connected to all the nodes in the next stage, and
generating the optimal path between the source and destination locations, each edge being associated with an overall measure for navigating through a selected edge and generating a pareto front, wherein a set of pareto efficient route solutions is generated through a routing process in a selected scenario, and wherein the pareto route solutions are dynamically grouped based on the navigation risk to select the optimized route by the route selector, and
providing the selected optimized route as output on the routing interface unit.

10. The automated dynamic routing method according to claim 9, further comprising: for selecting, by the route selector, the most optimized route among the routes, using the values of the aggregated exposure score measure of the routes, wherein the most optimized route is triggered by the route having the smallest aggregated exposure score measure value, or by the route having the smallest maximum value of a time- and location dependent measured exposure values along each route.

11. The automated dynamic routing method according to claim 9, further comprising: continuously acquiring the route parameters along the routes from one or more measuring devices and/or sensors associated with the vehicle and/or the mobile device and/or the user and/or external contextual measuring systems.

12. The automated dynamic routing method according to claim 9, further comprising:
continuously monitoring the route parameters along the routes to determine change in the route parameters along the routes,
in response to a change in the measured route parameters for at least one of the one or more routes, dynamically re-determining at least partially the time- and location dependent measured exposure values along each route based on the route parameters,
in response to at least one changed time- and location dependent measured exposure value, generating an updated exposure score for each of the routes, determining an updated optimized route among the one or more routes, and
providing the updated optimized route as output on the embedded routing interface unit.

13. The automated dynamic routing method according to claim 9, further comprising: continuously processing the monitored route parameters to automatically detect a change in route parameters in near-real time.

14. The automated dynamic routing method according to claim 9, further comprising: communicating at least one of a notification or control instructions to an automobile control unit to display the optimized route or an updated optimized route or control the driving of the automobile by generating adapted steering signals to navigate on the optimized route or an updated optimized route.
